(19) United States
(12) Patent Application Publication
(10) Pub. No.: US 2020/0118161 A1
(43) Pub. Date: Apr. 16, 2020

(54) SYSTEMS AND METHODS FOR A PLATFORM TO MANAGE AND EXECUTE MARKETING CAMPAIGNS

(71) Applicant: Qwasi, Inc., New York, NY (US)

(72) Inventors: Leon Samuel, New York, NY (US); Jon Thies, Malvern, PA (US); Karl J. Montemayor, Santa Clara, CA (US)

(73) Assignee: Qwasi, Inc., New York, NY (US)

(21) Appl. No.: 16/423,816

(22) Filed: May 28, 2019

Related U.S. Application Data
(63) Continuation of application No. 15/606,939, filed on May 26, 2017, now abandoned.
Application No. 15/606,939 is a continuation of application No. 14/586,457, filed on Dec. 30, 2014, now abandoned.
(60) Provisional application No. 61/921,945, filed on Dec. 30, 2013.
(60) Provisional application No. 61/921,967, filed on Dec. 30, 2013.

(51) Int. Cl. G06Q 30/02; H04W 4/08; G06Q 50/00

(52) U.S. Cl. CPC G06Q 30/0246; H04W 4/08; G06Q 50/01; G06Q 30/0269; G06Q 30/0207; G06Q 30/0242; G06Q 30/0267

(57) ABSTRACT

A system receives a marketing campaign from an advertiser. The marketing campaign identifies tasks to be performed by users on social networks. The system provides a cellular message to each of the plurality of cellular devices. The system retrieves a plurality of activities performed by each of the users of the plurality of cellular devices at each of the one or more social networks. The system identifies, for a user of the users, that the user performed activities responsive to receiving the cellular message identifying the advertiser. The system determines that the activities match the tasks included in the marketing campaign. The system then provides, to the cellular device of the user via at least one of the one or more social networks, a notification identifying the advertiser in response to determining that the one or more activities match the one or more tasks included in the marketing campaign.

### RELATED APPLICATIONS

This application claims priority to and is a continuation of U.S. patent application Ser. No. 15/606,939, entitled “SYSTEMS AND METHODS FOR A PLATFORM TO MANAGE AND EXECUTE MARKETING CAMPAIGNS” filed May 26, 2017 which in turn claims priority to and is a continuation of U.S. patent application Ser. No. 14,586,457, entitled “SYSTEMS AND METHODS FOR A PLATFORM TO MANAGE AND EXECUTE MARKETING CAMPAIGNS” filed Dec. 30, 2014, which application claims the benefit of and priority to US. Provisional Application No. 61/921,945, entitled “SYSTEMS AND METHODS FOR A PLATFORM TO MANAGE AND EXECUTE MARKETING CAMPAIGNS” filed on Dec. 30, 2013 and US. Provisional Application No. 61/921,967, entitled “SYSTEMS AND METHODS FOR COLLECTING, MANAGING AND USING SUBSCRIBER INFORMATION” filed on Dec. 30, 2013, all of which are incorporated herein by reference in their entirety for all purposes.

### FIELD OF THE DISCLOSURE

The present application relates generally to collecting, managing and using subscriber information, and in particular, relates to collecting, managing and using subscriber information via a subscriber information management system. Moreover, the present application relates to a platform for aggregating and using social network data across a plurality of social network platforms, and in particular, to a platform to manage and execute marketing campaigns.

### BACKGROUND

Nowadays, more and more users are engaging in activities across multiple platforms. Although most platforms are monitoring user activities to understand user behaviors, the information that the platforms are using to do so is limited to the activities the user performs on their platform and any information the user provides to the platform. As a result, platforms are only able to partially understand user behaviors.

### SUMMARY

More and more people are engaging in activities across multiple platforms that are logging activity data performed within their platform. For instance, a retailer is logging all shopping related activity performed by a customer at the retailer, a social network website is logging all social network related activities performed by the user at the social networking platform, a website is logging content viewing activity performed by a customer at the website and so forth. Although most platforms are monitoring user activities to understand user behaviors, the information that the platforms have access to is limited to the activities the user performs on their platform and any information the user provides directly to the platform. Although the logged activity data of users is somewhat useful to the platforms, these platforms oftentimes lack the context associated with the activity data of users. Stated in another way, the platforms are unaware of why the user performs a particular activity or what causes the user to perform such an activity. Moreover, the platforms are also unaware of activities the user performs before or after the user performs the particular activity. This is particularly true when users are engaging in activities at multiple platforms at around the same time. As a result, when a customer visits a particular retailer online and buys a shirt, the retailer is often unaware of the path the customer took to buy the particular shirt, whether the customer visited another site to see other shirts or to determine if the price of the shirt was appropriate, whether the customer saw a post on a social networking site regarding the shirt or the retailer, and the like. There is a desire on the part of the retailer to receive additional information about the user's activities at other platforms to see how the user reached the decision to buy the shirt. Extending this further, there is a desire to be able to share information about a user across multiple platforms to better understand user behavior.

Various embodiments disclosed herein are directed to methods and systems for collecting, managing and using subscriber data. Users, such as subscribers, can engage in activities across various platforms, including email, SMS, voice calls, social network platforms, third-party websites and applications, amongst others. Most of these platforms are monitoring the users' activities in their respective platform and associating attributes to users based on the respective user's activities. The data collected by these individual platforms is contained within each individual platform and currently not shared across multiple platforms even though such data may be valuable to other platforms.

Consider an advertiser that runs an advertising campaign. One of the advertiser's goals is to learn how users respond to the advertising campaign. In one example, the advertiser can establish an SMS marketing campaign broadcasting an SMS message to all of its subscribers. The SMS message can include a link to the advertiser's website and a 10% coupon. One of the subscribers that receives the message opens the message and clicks on the link contained in the SMS message. The subscriber visits the website and doesn't convert. A few minutes later, the subscriber then goes on to a social networking platform and shares the advertiser's website with friends in his social network. One of his friends sees the advertiser's website, clicks on the link and makes a purchase at the advertiser's website. Based on this scenario, it is likely that the SMS message sent to the subscriber resulted in the purchase made by the subscriber's friend. However, at present, the advertiser has no way of knowing that the SMS message likely resulted in the friend's purchase.

According to aspects of the present disclosure, the present disclosure describes methods and systems for collecting, managing and using subscriber information. A communications technology platform can establish interfaces through which subscribers allow the subscriber information management system to retrieve subscriber information from a plurality of content sources and store the retrieved subscriber information in one or more databases. These content sources can include the subscriber's devices, one or more social networking platforms to which the subscriber belongs, mobile phone service carriers, third-party applications or websites with which the subscriber is capable of receiving subscriber information from, amongst others. The databases of the communication platform can be configured to store subscriber records that include subscriber information pertaining to each subscriber.

The subscriber information included in a subscriber record can be obtained from information provided by the subscriber, information the subscriber has shared on social network platforms, third party content sources, and mobile phone log information, amongst others.

In some implementations, when a subscriber of the subscriber information management system signs up as a subscriber, the subscriber can grant the subscriber information management system to access information of the subscriber that the subscriber has provided with other platforms. In some implementations, the subscriber can authorize the subscriber information management system to receive subscriber information from the various content sources. The subscriber information management system can then establish communication means with each of the various content sources and retrieve subscriber information related to the subscriber. The subscriber information management system can parse details from the subscriber information received from the various content sources and store them in the subscriber record specific to the subscriber.

As described herein, the subscriber record includes information about the subscriber that has been collected from a plurality of unrelated content sources. The subscriber information management system can manage the collected information received from the various content sources. In some implementations, managing the collected information can include associating values to attributes based on the collected information. Attributes can serve as keys in a database and can correspond to criteria used by advertisers, marketers, or any other entity that may be interested in identifying subscribers or their characteristics. Example attributes can be demographic information (gender, age, race); interests (sports, music, arts); household information (relationship status, household size), personal information (phone number, area code, zip code, address), employment information (employer name, work history), amongst others. In addition, the collected data can also include information about actions performed by the user, for instance, the websites, webpages or links accessed by a subscriber, the social networking activity of the subscriber (posts on walls, comments, likes, +1, Retweets, etc.), amongst others. In addition, the collected data can include information from the subscriber's phone logs, such as a list of numbers the subscriber called or received calls or SMS messages from, amongst others. In addition, the collected information can include geographic locations the subscriber visited, amongst others. It should be appreciated that all of this information can be collected in response to the subscriber opting in to allow the subscriber information management system to collect such information.

The subscriber information management system can be configured to use the collected information to learn more about the subscriber. This information can be helpful to provide the subscriber more relevant information based on the collected information related to the subscriber. In some implementations, the subscriber can receive information from one or more clients of the subscriber information management system. This can allow the subscriber to receive more relevant information while at the same time, allow a client, such as a marketer or advertiser, to send the subscriber information that is of interest to the subscriber.

Consider the following case scenario of an advertiser seeking to launch a marketing campaign to subscribers. By way of the present disclosure, a tennis retailer can submit a request to the subscriber information management system to establish a marketing campaign that involves sending an SMS message to all subscribers that are between 18 and 35 years old, indicate tennis as an interest of theirs, have an area code of (617) corresponding to the greater Boston area and in the past thirty days, have mentioned the word ‘tennis’ in a social networking platform. The subscriber information management system can perform a lookup for all subscribers that match the criteria indicated above. Via the subscriber record of the database storing subscriber information, the subscriber information management system can identify a list of matching subscribers and send the subscribers an SMS as per the marketing campaign. Moreover, the subscriber information management system can also monitor the subscriber's response to the SMS by identifying and retrieving activities the subscriber performed shortly after accessing the SMS from the various content sources. For example, if the subscriber clicked on a link included in the SMS, visited the website of the advertiser, then shared a page of the advertiser on the subscriber's Facebook wall, then visited another website and made a purchase, all of these activities of the subscriber can be tracked and identified by the various content sources and shared with the subscriber information management system. The subscriber information management system can then share this sequence of events with the advertiser, at an individual subscriber level, or at a higher level, to see how the subscribers behaved in response to the SMS. The ability to determine the subscriber's behavior can be very useful in designing marketing campaigns and tailoring a particular marketing campaign based on the behaviors of the subscribers being targeted.

According to another aspect, a method for collecting and managing subscriber activity information across a plurality of content sources includes establishing, by a subscriber information management system comprising one or more processors intermediary to one or more advertisers, cellular devices of a plurality of subscribers and one or more servers of a plurality of unrelated content sources storing subscriber activity information related to activities performed by the plurality of subscribers, a plurality of interfaces with the servers of each of the plurality of content sources. The servers of the plurality of content sources are configured to provide the subscriber activity information to the subscriber information management system. The subscriber information management system receives, for each subscriber-content source pair, the subscriber activity information of the subscriber related to the content source via the interface established between the subscriber information management system and the servers of the content source. The subscriber information management system stores, for each subscriber, the retrieved subscriber activity information in a subscriber record specific to the subscriber included in a database. The subscriber information management system executes a marketing campaign of an advertiser of the one or more advertisers. The marketing campaign identifies a targeting criteria related to activities at one or more content sources of the plurality of content sources. The subscriber information management system then tracks a performance of the marketing campaign based on activities performed by the subscribers selected from the targeting criteria. In some implementations, the subscriber information management system receives a request to establish a connection with a server of a content source of the plurality of content sources responsive to the server of the content source executing a script of the subscriber information management system. In some implementations, receiving, for each subscriber-content source pair, the subscriber activity information of the subscriber related to the content sources includes receiving the subscriber activity information in a format specific to the content source.

In some implementations, the subscriber information management system extracts values of one or more attributes from the received subscriber activity information. In some implementations, the subscriber information management system identifies a type of subscriber activity information received from the content source, determines, based on the type of subscriber activity information received, one or more attributes included in the subscriber activity information, identifies one or more values of the one or more attributes included in the subscriber activity information and stores the identified one or more values of the one or more attributes in a subscriber record of the subscriber to which the subscriber activity information corresponds.

In some implementations, executing a marketing campaign of an advertiser includes receiving, by the subscriber information management system, a request to send a notification to a subset of the plurality of subscribers based on the targeting criteria.

In some implementations, the subscriber information management system identifies, from the subscriber activity information stored in the subscriber records of the plurality of subscribers, the subset of the plurality of subscribers that satisfy the targeting criteria. The subscriber information management system generates the notification responsive to the request and transmits the notification to subscriber devices associated with the subset of the plurality of subscribers.

In some implementations, the request to send the notification identifies one or more types of notification to transmit to the subscriber device. In some implementations, the request to send the notification identifies one or more notification delivery channels.

In some implementations, tracking the performance of the marketing campaign based on activities performed by the subscribers selected from the targeting criteria includes identifying one or more activities performed by the subscribers responsive to receiving the notification.

According to another aspect, a system for collecting and managing subscriber activity information across a plurality of content sources includes a subscriber information management system intermediary to one or more advertisers, cellular devices of a plurality of subscribers and one or more servers of a plurality of unrelated content sources storing subscriber activity information related to activities performed by the plurality of subscribers. The social media aggregation system includes a memory and one or more processors. The subscriber information management system establishes a plurality of interfaces with the servers of each of the plurality of content sources. The servers of the plurality of content sources are configured to provide the subscriber activity information to the subscriber information management system. The subscriber information management system receives, for each subscriber-content source pair, the subscriber activity information of the subscriber related to the content source via the interface established between the subscriber information management system and the servers of the content source. The subscriber information management system stores, for each subscriber, the retrieved subscriber activity information in a subscriber record specific to the subscriber included in a database. The subscriber information management system executes a marketing campaign of an advertiser of the one or more advertisers. The marketing campaign identifies a targeting criteria related to activities at one or more content sources of the plurality of content sources. The subscriber information management system then tracks a performance of the marketing campaign based on activities performed by the subscribers selected from the targeting criteria.

In some implementations, the subscriber information management system receives a request to establish a connection with a server of a content source of the plurality of content sources responsive to the server of the content source executing a script of the subscriber information management system. In some implementations, receiving, for each subscriber-content source pair, the subscriber activity information of the subscriber related to the content sources includes receiving the subscriber activity information in a format specific to the content source.

In some implementations, the subscriber information management system extracts values of one or more attributes from the received subscriber activity information. In some implementations, the subscriber information management system identifies a type of subscriber activity information received from the content source, determines, based on the type of subscriber activity information received, one or more attributes included in the subscriber activity information, identifies one or more values of the one or more attributes included in the subscriber activity information and stores the identified one or more values of the one or more attributes in a subscriber record of the subscriber to which the subscriber activity information corresponds.

In some implementations, executing a marketing campaign of an advertiser includes receiving, by the subscriber information management system, a request to send a notification to a subset of the plurality of subscribers based on the targeting criteria.

In some implementations, the subscriber information management system identifies, from the subscriber activity information stored in the subscriber records of the plurality of subscribers, the subset of the plurality of subscribers that satisfy the targeting criteria. The subscriber information management system generates the notification responsive to the request and transmits the notification to subscriber devices associated with the subset of the plurality of subscribers.

In some implementations, the request to send the notification identifies one or more types of notification to transmit to the subscriber device. In some implementations, the request to send the notification identifies one or more notification delivery channels.

In some implementations, tracking the performance of the marketing campaign based on activities performed by the subscribers selected from the targeting criteria includes identifying one or more activities performed by the subscribers responsive to receiving the notification.

As more and more users are engaging in activities across multiple online platforms, such as social media platforms like social networking websites, online deal websites, among others, businesses have also increased their social media marketing efforts across these multiple online platforms in an attempt to increase brand awareness and boost revenues. Some businesses are engaging in include creating social networking pages dedicated to their businesses, launching deals on daily deal sites, providing online coupon codes, tweeting, provided targeted advertising, amongst others. One of the challenges such businesses are facing as a result of these increased marketing efforts is analyzing the performance of these marketing efforts. In particular, smaller businesses do not have the resources to understand which efforts are improving sales and by how much, let alone how much it is costing the business to generate these improved sales. Stated in another way, businesses are engaging with customers but have not been able to aggregate, correlate, and measure the effectiveness of their efforts given the heterogeneous nature of the various online platforms, and further yet, make decisions on which marketing efforts to pursue or drop based on their effectiveness.

At present, each social media platform is limited in logging only those activities of the user that are performed within the social network platform. In this way, for a user that is both a Facebook user and a Twitter user, Facebook may be limited to only analyze the user's activities that are performed on the Facebook social network platform, while Twitter may be limited to only analyze the user's activities that are performed on the Twitter social network platform. As such, at present, a business that engages with a user who subscribes to both Facebook and Twitter currently maintains two separate accounts for this user and the business is unaware of the relationship between the Facebook profile and the Twitter profile of the user. As a result, a business fails to maximize its ability to understand the business's customers simply because the business has no way of using the information obtained through Facebook in its marketing efforts on Twitter and vice versa. Broadly speaking, businesses currently are unable to optimize their marketing efforts since the businesses are unable to aggregate and correlate information across multiple online platforms.

According to one aspect, a method of executing a cross-platform marketing campaign is described. A social media aggregation system including one or more processors intermediary to an advertiser and a plurality of cellular devices receives a marketing campaign from the advertiser. The marketing campaign identifies one or more tasks to be performed by users of the plurality of cellular devices on one or more social networks. The social media aggregation system provides a cellular message to each of the plurality of cellular devices, the cellular message identifying the advertiser. The social media aggregation system retrieves a plurality of activities performed by each of the users of the plurality of cellular devices at each of the one or more social networks. The social media aggregation system identifies, for a user of the users of the plurality of cellular devices, that the user performed one or more activities of the plurality of activities responsive to receiving the cellular message identifying the advertiser. The social media aggregation system determines that the one or more activities match the one or more tasks included in the marketing campaign. The social media aggregation system then provides, to the cellular device of the user via at least one of the one or more social networks, a notification identifying the advertiser in response to determining that the one or more activities match the one or more tasks included in the marketing campaign.

In some implementations, the cellular message includes a link, which when clicked, causes a social network application to launch on the cellular device. In some implementations, the one or more tasks include one of sharing of, commenting on or expressing an indication of interest on a particular content included in at least one of the one or more social networks.

In some implementations, the social media aggregation system can receive, from each of the cellular devices, an indication to access content of the social networks related to the user of the cellular device. In some implementations, the social media aggregation system can receive data corresponding to activities performed at the one or more social networks via native applications installed on the cellular devices of users.

In some implementations, the social media aggregation system can receive data corresponding to one or more activities performed by the user on the cellular device from one or more services executing on the cellular device. In some such implementations, the one or more services include a phone service, an email service, an instant messaging service, and a camera service.

In some implementations, retrieving a plurality of activities performed by each of the users of the plurality of cellular devices at each of the one or more social networks includes retrieving, for each user, activity data corresponding to a particular activity. The activity data can include a time stamp indicating a time the activity was performed and a location stamp indicating a location of the user when the activity was performed a time stamp.

In some implementations, the notification includes an electronic content item redeemable towards a purchase of a product or service promoted by the advertiser. In some implementations, the user of the cellular device is a first user and the social media aggregation system further determines that a second user performed a second activity on a content item responsive to the first user performing a first activity on the content item and provides, to the cellular device of the first user, the notification responsive to determining that the second user performed the second activity on the content item.

According to another aspect, a system of executing a cross-platform marketing campaign, includes a social media aggregation system intermediary to an advertiser and a plurality of cellular devices. The social media aggregation system includes a memory and one or more processors. The social media aggregation system receives a marketing campaign from the advertiser. The marketing campaign identifies one or more tasks to be performed by users of the plurality of cellular devices on one or more social networks. The social media aggregation system provides a cellular message to each of the plurality of cellular devices, the cellular message identifying the advertiser. The social media aggregation system retrieves a plurality of activities performed by each of the users of the plurality of cellular devices at each of the one or more social networks. The social media aggregation system identifies, for a user of the users of the plurality of cellular devices, that the user performed one or more activities of the plurality of activities responsive to receiving the cellular message identifying the advertiser. The social media aggregation system determines that the one or more activities match the one or more tasks included in the marketing campaign. The social media aggregation system then provides, to the cellular device of the user via at least one of the one or more social networks, a notification identifying the advertiser in response to determining that the one or more activities match the one or more tasks included in the marketing campaign.

In some implementations, the cellular message includes a link, which when clicked, causes a social network application to launch on the cellular device. In some implementations, the one or more tasks include one of sharing of, commenting on or expressing an indication of interest on a particular content included in at least one of the one or more social networks.

In some implementations, the social media aggregation system can receive, from each of the cellular devices, an indication to access content of the social networks related to the user of the cellular device. In some implementations, the social media aggregation system can receive data corresponding to activities performed at the one or more social networks via native applications installed on the cellular devices of users.

In some implementations, the social media aggregation system can receive data corresponding to one or more activities performed by the user on the cellular device from one or more services executing on the cellular device. In some such implementations, the one or more services include a phone service, an email service, an instant messaging service, and a camera service.

In some implementations, retrieving a plurality of activities performed by each of the users of the plurality of cellular devices at each of the one or more social networks includes retrieving, for each user, activity data corresponding to a particular activity. The activity data can include a time stamp indicating a time the activity was performed and a location stamp indicating a location of the user when the activity was performed a time stamp.

In some implementations, the notification includes an electronic content item redeemable towards a purchase of a product or service promoted by the advertiser. In some implementations, the user of the cellular device is a first user and the social media aggregation system further determines that a second user performed a second activity on a content item responsive to the first user performing a first activity on the content item and provides, to the cellular device of the first user, the notification responsive to determining that the second user performed the second activity on the content item.

### BRIEF DESCRIPTION OF THE DRAWINGS

FIG. 1A is a block diagram depicting an embodiment of a network environment comprising local devices in communication with remote devices.

FIGS. 1B-1D are block diagrams depicting embodiments of computers useful in connection with the methods and systems described herein.

FIG. 2 is a block diagram illustrating a computer networked environment for collecting, managing and using subscriber information.

FIG. 3 is a block diagram of an architecture for implementing the subscriber information management system.

FIG. 4 is a flow chart of a method for collecting, managing and using subscriber information.

FIG. 5 is a block diagram illustrating a computer networked environment for a social media platform for creating and executing marketing campaigns.

FIG. 6 is a flow chart of a method for creating and executing marketing campaigns.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein.

Section B describes a subscriber information management system which may be useful for practicing embodiments described herein.

Section C describes a meta-social platform which may be useful for practicing embodiments described herein.

### A. Computing and Network Environment

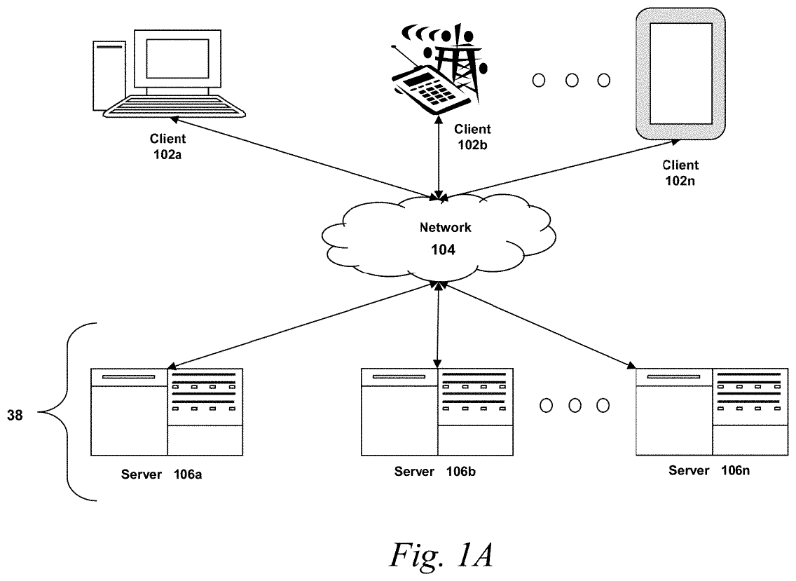

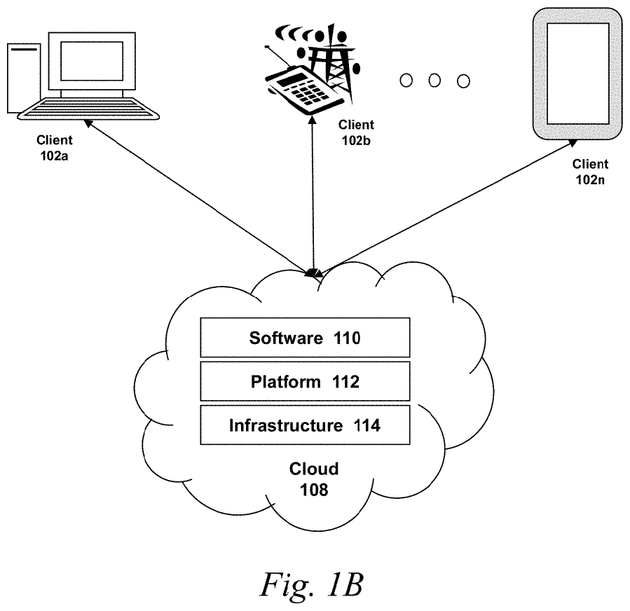

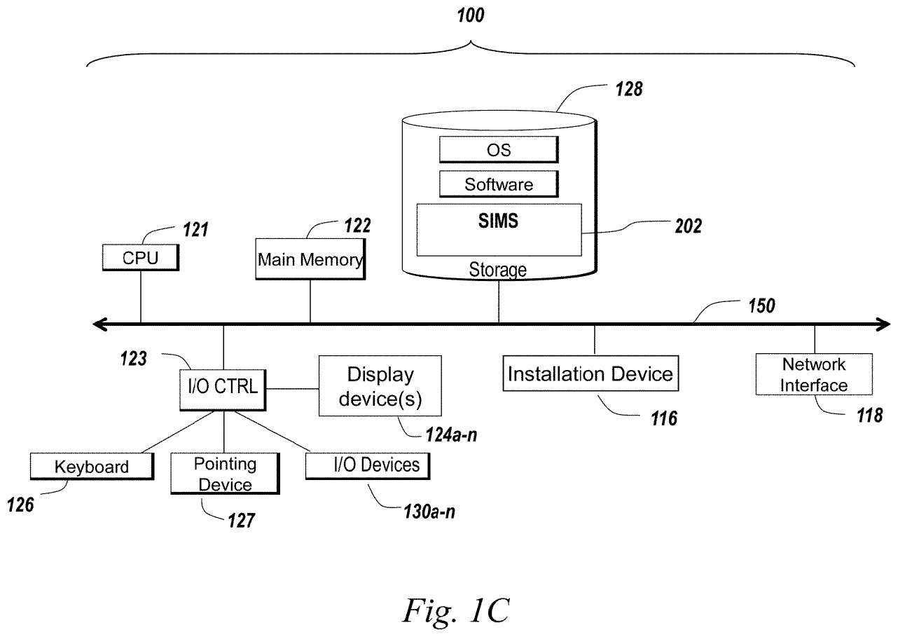

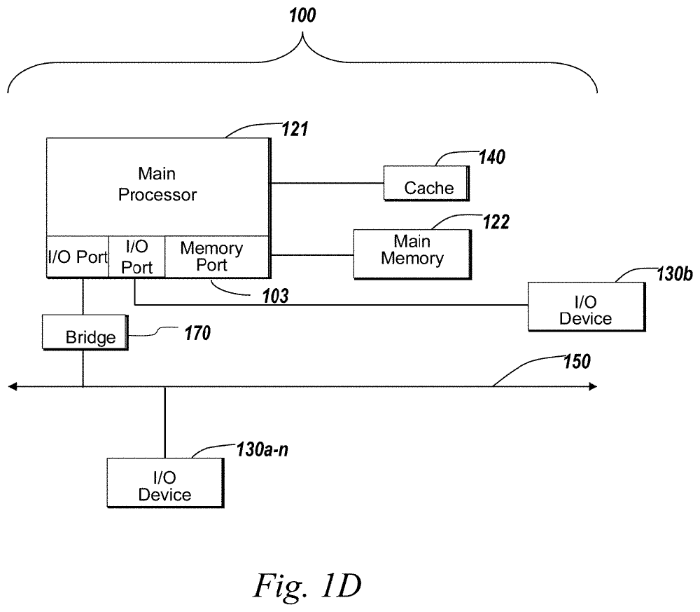

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

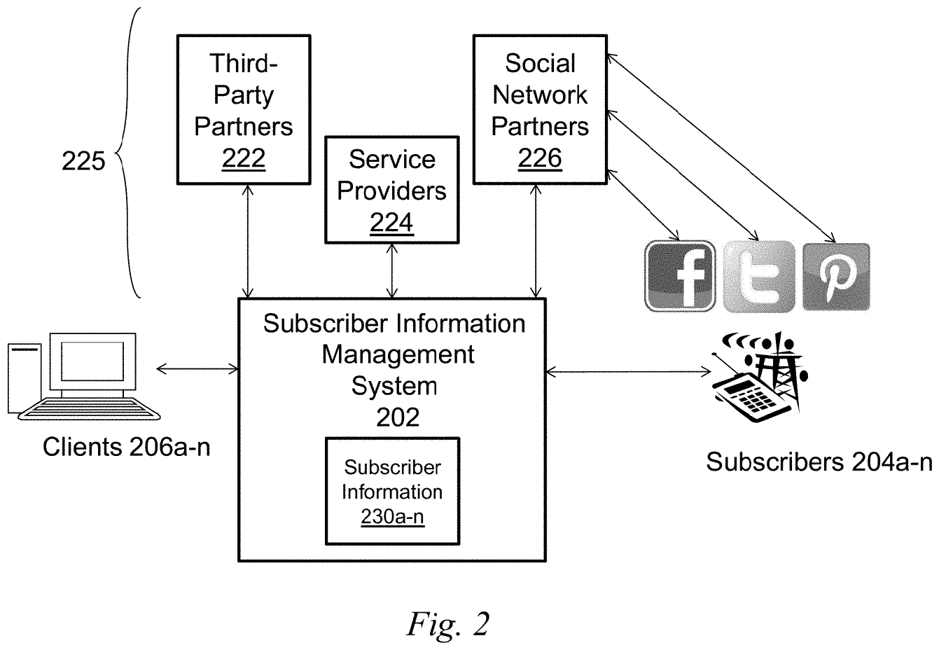

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and software of a subscriber information management system (SIMS) 202. Details of the SIMS 202 are described below with respect to the description of FIG. 2. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAIVI), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAIVI), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WIT, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HIVID). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the content distribution system. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via an I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is an eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Subscriber Information Management System

More and more people are engaging in activities across multiple platforms that are logging activity data performed within their platform. For instance, a retailer is logging all shopping related activity performed by a customer at the retailer, a social network website is logging all social network related activities performed by the user at the social networking platform, a website is logging content viewing activity performed by a customer at the website and so forth. Although most platforms are monitoring user activities to understand user behaviors, the information that the platforms have access to is limited to the activities the user performs on their platform and any information the user provides directly to the platform. Although the logged activity data of users is somewhat useful to the platforms, these platforms oftentimes lack the context associated with the activity data of users. Stated in another way, the platforms are unaware of why the user performs a particular activity or what causes the user to perform such an activity. Moreover, the platforms are also unaware of activities the user performs after the user performs the particular activity. This is particularly true when users are engaging in activities at multiple platforms at around the same time. As a result, when a customer visits a particular retailer online and buys a shirt, the retailer is often unaware of the path the customer took to buy the particular shirt, whether the customer visited another site to see other shirts or to determine if the price of the shirt was appropriate, whether the customer saw a post on a social networking site regarding the shirt or the retailer, and the like. There is a desire on the part of the retailer to receive additional information about the user's activities at other platforms to see how the user reached the decision to buy the shirt. Extending this further, there is a desire to be able to share information about a user across multiple platforms to better understand user behavior.

Various embodiments disclosed herein are directed to methods and systems for collecting, managing and using subscriber data. Users, such as subscribers, can engage in activities across various platforms, including email, SMS, voice calls, social network platforms, third-party websites and applications, amongst others. Most of these platforms are monitoring the users activities in their respective platform and associating attributes to users based on the respective user's activities. The data collected by these individual platforms is contained within each individual platform and currently not shared across multiple platforms even though such data may be valuable to other platforms.

Consider an advertiser that runs an advertising campaign. One of the advertiser's goals is to learn how users respond to the advertising campaign. In one example, the advertiser can establish an SMS marketing campaign broadcasting an SMS message to all of its subscribers. The SMS message can include a link to the advertiser's website and a 10% coupon. One of the subscribers that receives the message opens the message and clicks on the link contained in the SMS message. The subscriber visits the website and doesn't convert. A few minutes later, the subscriber then goes on to a social networking platform and shares the advertiser's website with friends in his social network. One of his friends sees the advertiser's website, clicks on the link and makes a purchase at the advertiser's website. Based on this scenario, it is likely that the SMS message sent to the subscriber resulted in the purchase made by the subscriber's friend. However, at present, the advertiser has no way of knowing that the SMS message likely resulted in the friend's purchase.

According to aspects of the present disclosure, the present disclosure describes methods and systems for collecting, managing and using subscriber information. A communications technology platform can establish interfaces through which subscribers allow the subscriber information management system to retrieve subscriber information from a plurality of unrelated content sources and store the retrieved subscriber information in one or more databases. These content sources can include the subscriber's devices, one or more social networking platforms to which the subscriber belongs, mobile phone service carriers, third-party applications or websites with which the subscriber is capable of receiving subscriber information from, amongst others. The databases of the communication platform can be configured to store subscriber records that include subscriber information pertaining to each subscriber.

The subscriber information included in a subscriber record can be obtained from information provided by the subscriber, information the subscriber has shared on social network platforms, third party content sources, mobile phone log information, amongst others.

In some implementations, when a subscriber of the subscriber information management system signs up as a subscriber, the subscriber can grant the subscriber information management system to access information of the subscriber that the subscriber has provided with other platforms. In some implementations, the subscriber can authorize the subscriber information management system to receive subscriber information from the various content sources. The subscriber information management system can then establish communication means with each of the various content sources and retrieve subscriber information related to the subscriber. The subscriber information management system can parse details from the subscriber information received from the various content sources and store them in the subscriber record specific to the subscriber.

As described herein, the subscriber record includes information about the subscriber that has been collected from a plurality of unrelated content sources. The subscriber information management system can manage the collected information received from the various content sources. In some implementations, managing the collected information can include associating values to attributes based on the collected information. Attributes can serve as keys in a database and can correspond to criteria used by advertisers, marketers, or any other entity that may be interested in identifying subscribers or their characteristics. Example attributes can be demographic information (gender, age, race); interests (sports, music, arts); household information (relationship status, household size), personal information (phone number, area code, zip code, address), employment information (employer name, work history), amongst others. In addition, the collected data can also include information about actions performed by the user, for instance, the websites, webpages or links accessed by a subscriber, the social networking activity of the subscriber (posts on walls, comments, likes, +1, Retweets, etc.), amongst others. In addition, the collected data can include information from the subscriber's phone logs, such as a list of numbers the subscriber called or received calls or SMS messages from, amongst others. In addition, the collected information can include geographic locations the subscriber visited, amongst others. It should be appreciated that all of this information can be collected in response to the subscriber opting in to allow the subscriber information management system to collect such information.

The subscriber information management system can be configured to use the collected information to learn more about the subscriber. This information can be helpful to provide the subscriber more relevant information based on the collected information related to the subscriber. In some implementations, the subscriber can receive information from one or more clients of the subscriber information management system. This can allow the subscriber to receive more relevant information while at the same time, allow a client, such as a marketer or advertiser, to send the subscriber information that is of interest to the subscriber.

Consider the following case scenario of an advertiser seeking to launch a marketing campaign to subscribers. By way of the present disclosure, a tennis retailer can submit a request to the subscriber information management system to establish a marketing campaign that involves sending an SMS message to all subscribers that are between 18 and 35 years old, indicate tennis as an interest of theirs, have an area code of (617) corresponding to the greater Boston area and in the past thirty days, have mentioned the word ‘tennis’ in a social networking platform. The subscriber information management system can perform a lookup for all subscribers that match the criteria indicated above. Via the subscriber record of the database storing subscriber information, the subscriber information management system can identify a list of matching subscribers and send the subscribers an SMS as per the marketing campaign. Moreover, the subscriber information management system can also monitor the subscriber's response to the SMS by identifying and retrieving activities the subscriber performed shortly after accessing the SMS from the various content sources. For example, if the subscriber clicked on a link included in the SMS, visited the website of the advertiser, then shared a page of the advertiser on the subscriber's Facebook wall, then visited another website and made a purchase, all of these activities of the subscriber can be tracked and identified by the various content sources and shared with the subscriber information management system. The subscriber information management system can then share this sequence of events with the advertiser, at an individual subscriber level, or at a higher level, to see how the subscribers behaved in response to the SMS. The ability to determine the subscriber's behavior can be very useful in designing marketing campaigns and tailoring a particular marketing campaign based on the behaviors of the subscribers being targeted.

Referring now to FIG. 2A, a block diagram depicting an environment comprising a subscriber information management system for collecting, managing and using subscriber information is shown. The subscriber information management system 202 facilitates the management, control and use of subscriber information 230a-n of one or more subscribers 204a-n. The subscriber information management system 202 can be configured to communicate with one or more subscribers 204, one or more clients 206, and one or more of external content source platforms 225, including but not limited to third-party partners 222, service providers 224 and social network partners 226. In some implementations, the content source platforms 225 can also include one or more of the subscribers devices and the subscriber information management system itself 202.

The subscriber information management system 202 can be configured to communicate with the subscribers 204 via a mobile application or a web-based interface. The subscriber can download a mobile application through which the subscriber can share information with the subscriber information management system. The mobile application can include instructions that allow the mobile application to push notifications to the subscriber's device. In some implementations, the mobile application can push notifications from one or more clients of the subscriber information management system 202. The notifications, when accessed by the user, can cause a mobile application of the client that is previously installed on the subscriber's device to launch. In some implementations, the notifications can cause the subscriber to access one or more websites. In some implementations, the notifications can cause the subscriber to take one more actions such as watch a video, take a survey, visit a website, amongst others.

In some implementations, the subscriber's device 204 can include one or more other mobile applications corresponding to partners of the subscriber information management system. These partners can be entities that have entered into relationships with the subscriber information management system to allow the system 202 to retrieve subscriber information from the entities. In some implementations, the partners can have native applications installed on the subscriber's device and can include code, instructions, or any other software construct that allows the subscriber information management system 202 to collect subscriber information generated as a result of activities the subscriber performs at the partner's websites or mobile applications. In some implementations, the partners applications through which the subscriber interacts with the partners can include a script that allows information associated with the subscriber that is stored on the partner's servers to be provided to the subscriber information management system 202.

Third-party partners 222 can include any application, website or other entity that is capable of sharing subscriber information with the subscriber information management system 202. Examples of third-party partners 222 can include retailers, content curation websites, blogs, or other websites that logs subscriber information.

Service providers 224 can be carriers that provide cellular phone service, internet service providers or any other content delivery service providers capable of providing content to the subscriber. In some implementations, service providers can include cable or satellite TV service providers that are capable of logging subscriber information and sharing such information with the subscriber information management system 202. In some implementations, the service providers can log information related to calls made and received by the subscriber's device, locations and times of when the calls were made and received, internet browsing activity performed on the subscriber's device, location and time data associated with such activity, amongst others.

Social network partners 226 can include one or more social networks that are capable of sharing subscriber information with the subscriber information management system 202. Examples of social network partners 226 can include social networking websites, such as Facebook, Twitter, Pinterest, Instagram, amongst others.

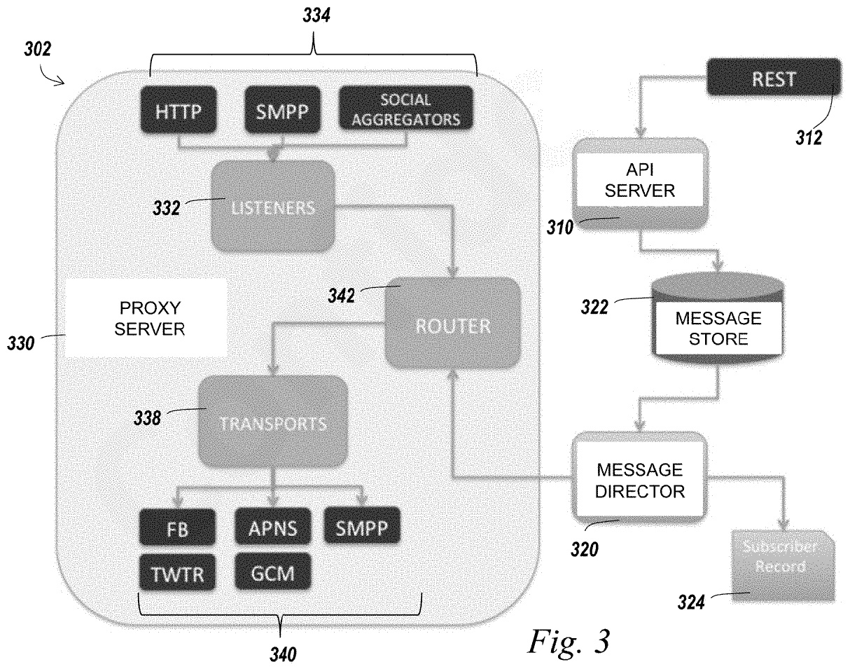

As will be described below with respect to FIG. 3, the subscriber information management system can be configured to establish connections with each of the content source platforms via APIs or some other communication interfaces.

The subscriber information 230 can be shared with or accessed by one or more clients 206a-n of the subscriber information management system 202. Subscriber information 230 can include any information associated with a subscriber, including but not limited to, information provided by a subscriber 204 directly to the subscriber information management system 202, or information provided by the subscriber to one or more of third-party partners 222 of the subscriber information management system 202, one or more phone carriers 224 to which the subscriber subscribes or one or more social network partners 226 of the subscriber information management system. In addition to information declared by the subscriber, subscriber information can include actions or activities performed by the subscriber 204 at any of the third-party partners, phone carriers or social network partners. Moreover, subscriber information 230 can include information relating to actions the subscriber 204 did not take. For example, if a subscriber does not click on a particular advertisement, such information may also be considered subscriber information. The subscriber information can also include information relating to other subscribers. For instance, subscriber information can include a list of the subscriber's social network friends, information associated with contacts of the subscriber on the subscriber's devices, amongst others.

Subscriber information related to activities of the subscriber can be associated with timestamps. These timestamps can correspond to the time the activities are performed by the subscriber, the time the subscriber information management system partner logs the activity or the time the subscriber information management system 202 receives the subscriber information related to the activity. In some implementations in which the timestamps are associated with activities as they are performed by the subscriber, the subscriber information can help provide a timeline of activities performed by the subscriber. These activities, when aggregated across multiple content source platforms 225, can help create paths or connections between activities performed at the various content source platforms 225.

For example, a subscriber is browsing his news feed in Facebook when he comes across an advertisement of a watch. He clicks on the advertisement and is directed to the website where the subscriber can purchase the watch. The subscriber then opens a new browser window and visits a second website, for example, www.google.com and enters the name of the watch and the model number as the search query. The subscriber then identifies a deal website, for example, www.slickdeals.net and visits the website to see that there is a coupon to purchase the watch at the advertiser's site. The user then returns to the website and purchases the watch after applying the coupon. The user then shares his purchase on Twitter, where a friend of the subscriber sees the tweet and visits the website where the subscriber purchased the watch. The friend then makes a purchase for the same watch on the website. If each of Facebook, the watch website, google.com, slickdeals.net and Twitter are content source platforms which are configured to share subscriber information with the subscriber information management system, all of the activities performed by the subscriber may be received by the subscriber information management system and stored in a subscriber record dedicated to the subscriber. Each of the subscriber's activities may be associated with timestamps to help arrange the order in which these actions were performed. In this way, the watch retailer can be able to identify a path taken by the subscriber to make the purchase and can even determine the path the subscriber took to find the coupon. Moreover, the watch retailer can also attribute the sale of the watch to the friend to the subscriber's tweet.

Additional details relating to the subscriber information management system 202 and the manner in which data is received from the various content source platforms is provided below with respect to FIG. 3.

FIG. 3 is a block diagram of an architecture for implementing the subscriber information management system. This architecture can be designed, constructed or configured to both serve as a stand-alone offering, as well as provide complete integration into an aggregator, operator or application provider's infrastructure such that the additional services can be added seamlessly. As a result, the subscriber information management system can not only be configured to receive subscriber information from a plurality of content source platforms, but also be configured to provide a multi-channel communications functionality. In particular, the subscriber information management can be configured to provide application push messaging side by side with SMS, MMS and identify Services and may exist both at the network level as well as application level.

The subscriber information management system can include a multi-channel messaging engine 302 that is designed, constructed or configured to serve as a unified engagement platform for SMS, push and social network communications. The multi-channel messaging engine provides an engagement management, deployment, subscription and notification system on top of a unified transport layer that provides a scalable, integrated and secure platform for communication between applications and subscribers.

The multi-channel messaging engine 302 may be divided into three primary core services: API 310, DIRECTOR 320, and PROXY 330. These services utilize the same backend data architecture, and are designed to work in distributed highly available clusters.

The multi-channel messaging engine 302 can also include a message store 322 that can be configured to store subscriber information for a plurality of subscribers 204. In some implementations, the message store can be configured to store millions of records, documents, and other forms of subscriber information included within the records and documents. Moreover, the multi-channel messaging engine 302 can include a plurality of subscriber records 324 configured to include all of the subscriber information pertaining to a subscriber that is collected from the content source platforms, from the subscriber and from other portions of the multi-channel messaging engine 302.

The API server 310 can serve as an interface to the rest of the world via servers of a plurality of unrelated content sources. The API server 310 can establish an interface with each of the content sources providing the multi-channel messaging engine message access to content stored on the content source platforms 225 (shown in FIG. 2), including but not limited to third-party integrators and partners. Additional details relating to the API server 310 are provided below.

The Message Director 320 provides a mechanism for allowing the API server 310 to be non-blocking in the messaging I/O path. Since the multi-channel messaging engine message store 322 contains millions of documents for as many recipients, complex lookups in the table are expensive. The Message Director 320 can process the messages and link them into individual subscribers folders 324, where details like read and deletion flags, read date, etc. are also contained. For example, when a subscriber retrieves their unread messages, their own document is queried for the list of message ids, not the message store itself, which will be queries directly for those specific messages. Therefore, the operation is a virtual a non-op in terms of resource utilization on the database.

The proxy server 330 can be designed, constructed or configured to serve as the heart of the multi-channel messaging engine 302 and provides the mechanisms by which messages are translated from either the multi-channel messaging engine API server 310, or other open and proprietary formats to all other formats. The proxy server 330 may be divided into two primary object categories: Protocol Listeners 332 and Protocol Transports 338. The ability to translate messages from various formats can be extended by simply adding new listeners or transports configured to establish communications with other content source platforms.

The protocol listeners 332 can provide socket-based services on the multi-channel messaging engine servers that listen or poll for incoming messages on various protocols. For example the SMPP listener provides a bind point for SMPP clients to deliver mobile originating (MO) messages into the multi-channel messaging system 302. This listener converts the message into a proprietary internal format of the multi-channel messaging engine 302 and passes it to a message router 342 for appropriate handling of the message, including but not limited to storing the message in the message store 322 and one or more subscriber records 324. In some implementations, the multi-channel messaging engine 302 has a basic routing table that provides a flow for messages from a listener to a transport.

The protocol transports 338 are the inverse of the listeners 332. The protocol transports 338 provide the mechanism for delivering a message into another system. The protocol transports 338 can provide access to applications for various protocols to send messages. For example, an SMS transport describes a particular SMPP connection to send text-messages out on, while an APNS transport contains the certificates necessary for sending push messages to IOS devices for a particular Application

In some implementations, to scale well, the multi-channel messaging system 302 can be designed to be modular. Various tasks are broken into instance servers that are connected via a common library and database schema.

An instance is defined as a process or cluster of processes that provide access to the multi-channel messaging engine. Each instance is divided into one or more services providing either an API access point or Transport manager. Every instance, however, can be fully self-contained. The instances themselves run within a node.js process as a single threaded asynchronous unit.

Instance API servers 310 provide REST of HTTPS access to developers facing the multi-channel messaging API server 310. The API can be broken down into four primary functions, Authentication, Partner, Push, and Device. The multi-channel messaging system 302, partners, developers, and subscriber based applications can access these various API entry points to accomplish respective tasks. Each API instance server provides access to one or more of these APIs, depending on performance and/or load constraints.

An Auth API instance provides authorization, authentication, and token services. These can be common across instances. Multi-channel messaging engine 302 can use the Oauth 2.0 authentication scheme for access to resources. The multi-channel messaging system can support both API and user authentication for resources. In some implementations, the Auth API instance can be used to allow the multi-channel messaging system to receive subscriber information from the various content source partners 225.

The partner API interface can be used for managing developers, applications, and transports. This API can provide the framework for which AIM and any other reseller/channel partner interface would be built around. It's where everything not related to getting messages to devices resides.

Push API is the primary interface for managing push applications, sending messages, managing customers, querying events, and pretty much anything and everything about getting stuff to phones, tablets, and other devices.

Subscriber device applications (i.e. iOS, Android, Web apps) access the device API to register, subscribe, and retrieve messages.

In some implementations, the multi-channel messaging system 302 can be configured to establish communications between the subscriber information management system 202 and the subscribers 202, the clients 204 and the various content sources platforms 225. The multi-channel messaging system 302 can use APIs through which the subscriber information management system 202 can retrieve subscriber information from the various content sources platforms 225. As described above, via the proxy server and the protocol listeners, the multi-channel messaging system 302 can receive messages from each of the content source platforms 225. In some implementations, the messages are received periodically, for example, daily. In some implementations, the messages can be received in real-time responsive to actions being taken by a subscriber at the content source platforms 225. In some implementations, the messages can include information corresponding to a single subscriber. In some implementations, the messages can include information corresponding to a plurality of subscribers. In some implementations, the messages can be sent from the various content sources platforms 225 responsive to a request from the multi-channel messaging system 302. In some implementations, the request can include authentication information to notify the content source platform that the multi-channel messaging system is authorized to receive subscriber information for a particular subscriber. In some implementations, the API establishing a communication between the multi-channel messaging system 302 and the particular content source platform can include a list of authorized subscribers 202 that have authorized the multi-channel messaging system 302 to receive subscriber information.

In some implementations, the multi-channel messaging system 302 can be configured to add a user as a subscriber responsive to the subscriber downloading an application on the subscriber's device, registering on a website, or providing some indication to subscribe. The subscriber can further provide the multi-channel messaging system, subscriber information including personal information, demographic information, information identifying one or more content source platforms to which the subscriber has subscribed, amongst others. By doing so, the multi-channel messaging system can request to gain access to the subscriber's account at the one or more content source platforms where the user has subscribed. These platforms include social networks, websites that have accounts, email accounts, amongst others.

As described herein, the multi-channel messaging system 302 can be configured to receive large volumes of data for a large number of subscribers from a plurality of different content source platforms. Moreover, the content that is collected can be received in a wide variety of formats. The multi-channel messaging system can be configured to convert the content from the format in which the messages are received to a proprietary internal format. Such a format may be configured such that the storing of such data can be simple and easy to retrieve.

In some implementations, the multi-channel messaging system 302 can use a document based NoSQL datastore, such as MongoDB, for example. This allows the multi-channel messaging system 302 to dynamically add attributes and records without having a predetermined schema. The objects do however have a loose contract of attributes called a model or schema, which the multi-channel messaging system 302 can implement at the code level. Fortunately, unlike traditional SQL systems, the multi-channel messaging system 302 can be configured to change these models on the fly and implement new document specifics.

The architecture of the multi-channel messaging database system separates Objects into two primary databases, the Common database, and one or more instance databases. For example Client A's entire messaging and application system can be fully segmented from Client B's, but authentication and events can be securely contained in the common DB. Many clients may fall into this model, however those that require a fully segmented system, and wish to forego the full benefit of analytics can be fully self-contained if necessary.

The Common Database or commondb, is a clustered database that holds all object collections that are common to all instances. For example, users and accounts reside in the commondb. All users, regardless of the instance their device accesses are authenticated to a central user database, and all accounts are contained w

The instance database can hold data unique to a specific instance. The DB architecture allows for separate client instances to be hosted or segmented on separate hardware or virtual machines from the other instances and the common infrastructure. The objects contained within the instance database include: applications, transports, and messages.

The following are high-level abstractions of the objects that reside in the multi-channel messaging engine database system. Objects are documents that are held in containers called collections. Every object has a unique ObjectId within the same database, these ids are used create links between objects.

User objects may simply be username (e-mail address) and password hash pairs. The user document also contains some simple data like a user's Full or Display name. Other data may be added later, but the primary purpose of this collection is for authentication and in order to keep it fast, it is best to keep it uncluttered. Users are therefore linked to one or more account documents, which hold more context specific data.

Every user belongs to at least one Developer or Customer account types. There are two other account types in a system, Instance, and Partner. An account is essentially a collection of users (or identities), along with simple access control and relevant attributes to that account type.

Every independent instance of the engine has an instance account. This is much like a root or admin account and contains the keys to the castle. This account has unrestricted API access.

Developer accounts are required to access the developer portal, Qwasi development sites, and any associated partner sites. Developer accounts are roughly organization based, and should be named as such. The first user added to the account at creation time is always the owner of that account and has full admin rights.

Partner accounts are logical groupings of Developer accounts. These accounts do not have users, beyond the primary admin account and allow for more fine grain segmentation of the system.

Customer accounts are a collection of identities that link to the same actual person. A Customer record contains all of the devices owned by that user, applications they are subscribed to, and a complete event history.

The customer accounts are the bread and butter of the multi-channel messaging engine. The manner in which data is stored in the customer accounts and in other databases is described in further detail with regard to the subscriber management API described below.

Each document contains a collection of Device Records and Application specific attributes. Customer Documents (QDoc) are owned by the multi-channel messaging system 302, as the multi-channel messaging system 302 generates them from the flow of data through the multi-channel messaging platform. Clients of the multi-channel messaging system 302 can add attributes to them on a per-Application basis.

When a subscriber device is initially registered, a placeholder tuple is created with a QDoc, a Device Record (DR), and a Transport Address (TA). If another DR and TA are created at a later time and the multi-channel messaging system 302 can build an association, the QDocs will be merged, which creates a unified record containing all of the information. The Application API provides the clients with a mechanism for adding public and private attributes to the QDoc, the goal being that the multi-channel messaging system 302 becomes both their messaging and datastore platform, facilitating all app-level operations. The QDoc essentially becomes their implicit goto data structure. To the clients of the multi-channel messaging system 302 customers, this may be entirely transparent. Additionally the partner API allows the client to give selective access to these attributes to other applications, or even other developers. The multi-channel messaging system 302 retains the right to use and attributes that are not explicitly protected, or generated via the multi-channel messaging engine.

Customer accounts are either automatically created by subscriber devices, or explicitly created by the users. Developers have fine-grained control over this aspect, and can use the multi-channel messaging system 302 as a mechanism for their own user authentication if they wish. Accounts that are automatically created by the device are marked as such, if a user later decides to create a real customer account, such that their messaging profile can persist across applications and devices, these accounts will be automatically unified.

Applications are a collection of simple attributes that describe a particular flow from provider to subscriber. Applications are owned by Developer accounts.

Device Records (DR) are a collection of simple device specific attributes (type: mobile, ios_phone, ios_table, android_phone, etc.), transport addresses (TA), and Event Records (ER). Each device is an entity independent of the application that created or registered it. The record itself is the property of Qwasi. Each device may have multiple transport address that are used by transport providers to deliver the message. For example an iPhone might have an APNS token for push, and a Mobile Number/ID for SMS/MMS.

Subscribers may give permission (opt-in) for an application to push to it. The opt-in mechanism varies by transport, for example SMS opt-in is implied when the subscriber provides the provider with a mobile number, where push opt-in requires additional action by the owner of the device. This authorization is per-transport address. For example a customer may have permission to send text messages, but not push notifications.

Event records may be used to store subscriber information and activities of the platforms. Every time an event associated with a device occurs, the event is logged. The classes of events are defined to include things like push, text, response, query, locate, etc. These events will come from all angles and aspects of the system and used along with other attributes on the QDoc to provide advance segmentation.

Notifications may be platform dependent. SMS, Apple Push Notification Service (APNS), Google Cloud Messaging (GCM), etc., all provide a relative simple mechanism for presenting a device user with a short message or alert. The Multi-channel messaging engine defines an engagement with a subscriber as two-pronged, an initial notification followed by and action or interaction with the subscriber. This action could be as simple as reading the message, or as complex as filling out a form or even initiating a real-time conversation.

The multi-channel messaging engine is capable of sending these notifications. Across all platforms, messages within the multi-channel messaging instance data store have the same format or schema:

var MessageAttachmentSchema = mojo.db.schema ({

type: { type: String, default: ‘application/json’ },
class: String,
data: String

}) ;
var MessageRecipientSchema = mojo.db.schema ({

user: mojo.db.schema.ObjectId,
read: Boolean,
deleted: Boolean,

}) ;
var MessageSchema = mojo.db.schema ({

type: String,
text: String,
rcpt: [MessageRecipientSchema],
app: {id: mojo.db.schema.ObjectId, name: String},
attachments: [MessageAttachmentSchema],
ops: { },
size: Number,
compressed: Boolean,
compressed_len: Number,
expires: Date,
isPrivate: {type: Boolean, default:false},
createdAt: { type: Date, default: Date.now },
sendAt: {type: Date, default: Date.now },
processed: {type: Boolean, default: false}

}) ;

From a developer's perspective, this can be overly complex. However, the system breaks this down into simply an alert (a short message, and small image) presented to the user as a notification of request for action, and the data associated with that action. It is ultimately up to the developer to define the actions, but the multi-channel messaging engine provides the storage and automatic retrieval of the payload associated with that engagement. For example, a real estate application could alert a buyer of a new property, the payload could contain the MLS ids that the application would then display to the user when the user clicks the notification.

A small set of standard payloads have been defined called multi-channel messaging actions that the multi-channel messaging engine SDK can present to the user with no additional changes to the subscriber application. These come in 3 categories: URL, HTML, Image. These are self-explanatory, and relatively simple. The major benefit is that the SDK does all this for “free” for the developer. The backend formats, stores, and delivers the notifications of these types automatically, and the subscriber application retrieves and presents these to the user in a clean easy to navigate interface. The developer does nothing to their mobile app other than add a library of the multi-channel messaging engine.

When enabled in the mobile app, messages retrieved by the device will be stored locally and always viewable by the subscriber without the need to re-download the message. This is a per-device option, but allows for offline of view of most Actions (HTML, and Images) as they would a simple Application specific e-mail system. They remain local until deleted by the user, or until they expire.

If a message is provided, the message may expire and may no longer be visible to any recipient after the specified date and time. When specified a private message will not be sharable via the integrated user interface, i.e. SMS, Facebook, and Twitter sharing will be disabled.

Clients of the multi-channel messaging system will likely never use the APIs directly. However, partners and more advanced client deployment will require integration with the multi-channel messaging platform directly. The entire platform runs in a server side JavaScript engine called node.js. It may be based on the Google V8 engine and is very robust and portable. This service provides a REST interface that sits on top of HTTPS, and is very simple, but can still be a barrier to entry for many projects. In order to simplify this, several SDKs can be provided that wrap these calls in various languages used by clients. There are two classes of SDKs, Service Provider SDKs and Client SDKs.

Provider SDKs are used by developers to push messages to clients over various transports. The multi-channel messaging system may provide SDKs for:

1. PHP

2. Microsoft .NET

3. JavaScript

4. Node.js

Client SDKs are libraries and frameworks that will run on client devices providing access to push authorization, opt-in/out systems, event management, and data consolidation. The multi-channel messaging system shall provide SDKs for:

1. Apple iOS

2. Google Android

3. JavaScript (Browser based)

The multi-channel messaging system creates developer and application records via the API. Application keys, secrets and pins are returned to the system. Push requires either the customer use the multi-channel messaging engine shared app, a co-branded application, or a custom registered application. This scenario assumes the simplest shared method.

The multi-channel messaging system provides a portal provides the customer with their unique PIN and QR code for the shared push system. They distribute this pin and code as they see fit, via marcom, SMS, email, etc.

The subscriber then scans the QR code or enters the pin into their multi-channel messaging system mobile app, thereby giving that application permission to push messages or notifications to their subscriber device via the multi-channel messaging engine shared application.

At this point, the multi-channel messaging system creates a QDoc, DR, TA tuple in the multi-channel messaging engine database. An initial event is logged, and that App Authorization is added to the TA.

The developer then logs into Qwasi.com and now sees a list of registered mobile devices they are permitted to push messages to and they build a campaign and push to the group. The campaign can be a marketing campaign.

If, instead of a push based campaign, the marketing campaign is one that relies on messaging the subscribers via SMS, the developer imports or adds mobile ids into the portal.

The multi-channel messaging system then creates a QDoc, DR, TA tuple in the multi-channel messaging engine database, and an initial event is logged, and that App Authorization is added to the TA. The developer then builds and schedules a campaign.

In some implementations, clients can create a campaign in which they can target the subscribers via one or more of a plurality of channels, including, push, SMS, social networks, amongst others.

The real power for a marketing campaign comes when there is enough information to construct a unified QDoc with multiple Device Records and/or Transport Addresses. The multi-channel messaging system can then show those associated end points to the customer and intelligently decide how to deliver a message. This is transparent to the user.

These associations can be created in various ways, including via passive association, two factor authorization or through subscriber accounts associated with the multi-channel messaging system. In passive association, subscribers will manually add their mobile address into the multi-channel messaging system app or SDK configuration sheet. In Two-Factor Authorization, when a subscriber authorizes an application with a pin or Quick Response (QR) code, the multi-channel messaging system can request their mobile number so the multi-channel messaging system can text them a token, which will be entered in to the app to verify their ownership of the device, allowing the multi-channel messaging system to create the association.

With respect to subscriber accounts, the multi-channel messaging system can explicitly offer subscribers the ability to register with the multi-channel messaging system when they install the multi-channel messaging system application. This allows them to manage their opt-in/outs, etc., perhaps even as deep as the aggregator or carrier level, at which point the multi-channel messaging system will collect information that can be added to the customer record.

The following provides additional implementation details relating to an application platform that allows clients of the subscriber information management system to create, manage, and launch mobile campaigns. As a part of this functionality, the Subscriber Management API allows customers to manage opt-in, opt-out and subscription settings for the subscribers of the system. The Subscriber Management API may be a subset of the full Campaign Manager API.

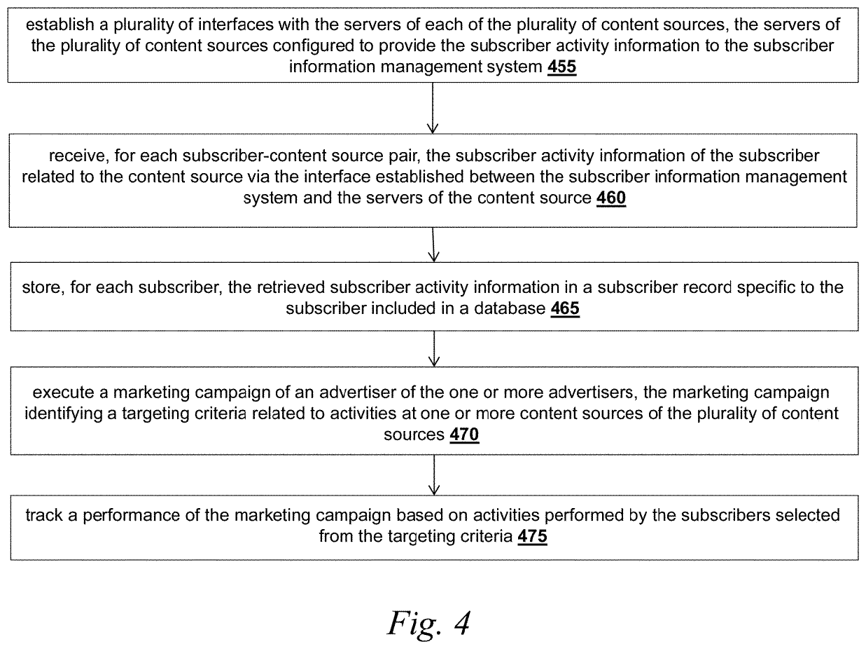

Referring now to FIG. 4, FIG. 4 is a flow chart of a method for collecting, managing and using subscriber information. In brief overview, a subscriber information management system comprising one or more processors intermediary to one or more advertisers, cellular devices of a plurality of subscribers and one or more servers of a plurality of unrelated content sources storing subscriber activity information related to activities performed by the plurality of subscribers establishes a plurality of interfaces with the servers of each of the plurality of content sources (BLOCK 455). The subscriber information management system receives, for each subscriber-content source pair, the subscriber activity information of the subscriber related to the content source via the interface established between the subscriber information management system and the servers of the content source (BLOCK 460). The subscriber information management system stores, for each subscriber, the retrieved subscriber activity information in a subscriber record specific to the subscriber included in a database (BLOCK 465). The subscriber information management system executes a marketing campaign of an advertiser of the one or more advertisers (BLOCK 470). The subscriber information management system then tracks a performance of the marketing campaign based on activities performed by the subscribers selected from the targeting criteria (BLOCK 475).

In further detail, the subscriber information management system establishes a plurality of interfaces with the servers of each of the plurality of content sources (BLOCK 455). The servers of the plurality of content sources are configured to provide subscriber activity information to the subscriber information management system. Subscriber activity information includes information related to activities associated with the subscriber. In some implementations, the subscriber activity information received from a content source is specific to the content source. In some implementations, the subscriber activity information can include any information the content source stores related to activities associated with the subscriber. For instance, if the subscriber is a user of a social network, subscriber activity information can include information related to content that the user views, shares, comments on, posts, or otherwise acts on. In some implementations, the subscriber activity information can include information related to the subscriber's social network connections and their activities. In some implementations, the subscriber activity information can include information related to the subscribers' interests, and groups. In some implementations, the subscriber activity information can include information related to information the subscriber has declared, including interests, demographic information, educational information, personal information, among others.

The subscriber information management system can establish an interface with one or more servers of each of the content sources. In some implementations, the subscriber information management system can establish a connection via an API. In some implementations, the API can be specific to the content source. In some implementations, the subscriber information management system can establish rules to retrieve data via the interface. In some implementations, the rules can include a frequency at which data is retrieved from the content source, the type of data retrieved, and the format in which to retrieve and/or process the retrieved data.

In some implementations, the subscriber information management system can receive a request to establish a connection with a server of a content source of the plurality of content sources responsive to the server of the content source executing a script of the subscriber information management system. In some implementations, receiving, for each subscriber-content source pair, the subscriber activity information of the subscriber related to the content sources includes receiving the subscriber activity information in a format specific to the content source.

In some implementations, the subscriber information management system can establish an interface with servers of the content sources via a service or application executing on the subscriber device. In some implementations, the subscriber device can be configured to receive subscriber activity information from a native application of the content source or may otherwise be configured to retrieve subscriber activity information from the content source. In some implementations, the native application of the content source executing on the subscriber device can include a snippet of code or script that causes the native application to provide subscriber activity data to the subscriber device and/or the subscriber information management system. In this way, the subscriber information management system can retrieve subscriber activity information of a subscriber from the content source via a service or application executing on a subscriber device.

The subscriber information management system receives, for each subscriber-content source pair, the subscriber activity information of the subscriber related to the content source via the interface established between the subscriber information management system and the servers of the content source (BLOCK 460). In some implementations, the subscriber information management system can retrieve subscriber activity information of a subscriber from the content source via a service or application executing on the subscriber device. In some implementations, the subscriber information management system can retrieve subscriber activity information in real-time as the subscriber performs actions that generate subscriber activity information stored by servers of the content source. In some implementations, the subscriber information management system can retrieve subscriber activity information periodically. In some implementations, the subscriber information management system can retrieve subscriber activity information according to a schedule. In some implementations, the subscriber information management system can retrieve subscriber activity information hourly, daily, weekly, or once every time period that can range from a minute to more than a week.

The subscriber information management system stores, for each subscriber, the retrieved subscriber activity information in a subscriber record specific to the subscriber included in a database (BLOCK 465). In some implementations, the subscriber information management system can convert the retrieved subscriber activity information into a format that can be stored in the database. In some implementations, the subscriber information management system can store the subscriber activity information after extracting values of one or more attributes from the received subscriber activity information. In some implementations, the subscriber information management system identifies a type of subscriber activity information received from the content source, determines, based on the type of subscriber activity information received, one or more attributes included in the subscriber activity information, identifies one or more values of the one or more attributes included in the subscriber activity information and stores the identified one or more values of the one or more attributes in a subscriber record of the subscriber to which the subscriber activity information corresponds.

In some implementations, the subscriber information management system can store subscriber activity information received from a plurality of content sources. In some implementations, the subscriber activity information can be tied to a particular content item. For instance, if the user sees a content item or ad on Facebook and shares the ad with his friends on Facebook, such that one of his friend's clicks on the ad and makes a purchase, the subscriber activity information can be stored in such a way that information performing to the content item can be accessed and retrieved easily via a lookup function. This may involve storing the data in such a way that allows an advertiser to see how the content item traverses across multiple subscribers and eventually results in a conversion. Moreover, the subscriber activity information may be stored such that an action of subscriber related to a content item that traverses through multiple communication or marketing channels, for example, from SMS to Facebook to Twitter to Email, may be easily identified. This may involve storing information about the content item, including a content item identifier. In some implementations, the subscriber information management system may associate a content item with a tag that is dynamically updated as the content item traverses through different marketing channels. In this way, a historical view of the content item can be identified from the tag.

The subscriber information management system executes a marketing campaign of an advertiser of the one or more advertisers (BLOCK 470). The marketing campaign identifies a targeting criteria related to activities at one or more content sources of the plurality of content sources. In some implementations, executing a marketing campaign of an advertiser includes receiving, by the subscriber information management system, a request to send a notification to a subset of the plurality of subscribers based on the targeting criteria. In some implementations, the subscriber information management system identifies, from the subscriber activity information stored in the subscriber records of the plurality of subscribers, the subset of the plurality of subscribers that satisfy the targeting criteria. The subscriber information management system generates the notification responsive to the request and transmits the notification to subscriber devices associated with the subset of the plurality of subscribers. In some implementations, the request to send the notification identifies one or more types of notification to transmit to the subscriber device. In some implementations, the request to send the notification identifies one or more notification delivery channels.

The targeting criteria can include one or more criteria for targeting subscribers to which to include in the marketing campaign. The criteria can include demographic information, subscriber device type information, one or more marketing channel information, one or more activities or interests, among others. For instance, an advertiser seeking to launch a marketing campaign to subscribers. By way of the present disclosure, a tennis retailer can establish a marketing campaign that involves sending an SMS message to all subscribers that are between 18 and 35 years old, indicate tennis as an interest of theirs, have an area code of (617) corresponding to the greater Boston area and in the past thirty days, have mentioned the word ‘tennis’ in a social networking website. The subscriber information management system can perform a lookup for all subscribers that match the criteria indicated above. Via the subscriber record of the database storing subscriber information, the subscriber information management system can identify a list of matching subscribers and send the subscribers an SMS as per the marketing campaign.

The subscriber information management system then tracks a performance of the marketing campaign based on activities performed by the subscribers selected from the targeting criteria (BLOCK 475). In some implementations, tracking the performance of the marketing campaign based on activities performed by the subscribers selected from the targeting criteria includes identifying one or more activities performed by the subscribers responsive to receiving the notification. In the example above, the subscriber information management system can also monitor the subscriber's response to the SMS by identifying and retrieving activities the subscriber performed shortly after accessing the SMS from the various content sources. For example, if the subscriber clicked on a link included in the SMS, visited the website of the advertiser, then shared a page of the advertiser on the subscriber's Facebook wall, then visited another website and made a purchase, all of these activities of the subscriber can be tracked and identified by the various content sources and shared with the subscriber information management system. The subscriber information management system can then share this sequence of events with the advertiser, at an individual subscriber level, or at a higher level, to see how the subscribers behaved in response to the SMS. The ability to determine the subscriber's behavior can be very useful in designing marketing campaigns and tailoring a particular marketing campaign based on the behaviors of the subscribers being targeted.

### C. Meta-Social Platform for Creating and Executing Marketing Campaigns

Consider for a moment the social media platform, FourSquare. FourSquare has attempted to bridge the gap between a social network and customer loyalty. By continually “checking in” at a location, such as a business, a user can become the “mayor” of the business if the user is one of the most frequent patrons of the business. The user can also see where friends in their social network are checking in, as well as find popular locations. The goal for the business is to improve customer loyalty and repeat visits. The goal for the patron is to receive rewards or special offers for their loyalty.

This business may also have a Facebook Page, Twitter Account, Web Site, have run Groupon and Living Social deals, a set of SCVNGR challenges, utilize email and mobile marketing campaigns, all in an effort to alert their patrons of special offers and promotions and to increase public awareness and hopefully increase revenue. The social media or communication platforms are fantastic tools to accomplish those goals, but the problem the business now faces is determining how to aggregate, correlate, and measure the effectiveness and make decisions given the heterogeneous nature of the data sources. Can this business determine if those who participated in a Groupon campaign are fans of the Facebook Page, or members of the email list? To make matters worse, imagine if the business is a franchise, or has affiliate businesses, or even other locations that are running similar campaigns. Leveraging the customers' social graphs given the variety of marketing campaigns is not an easy challenge to overcome.

As more and more users are engaging in activities across multiple online platforms, such as social media platforms like social networking websites, online deal websites, amongst others, businesses have also increased their social media marketing efforts across these multiple online platforms in an attempt to increase brand awareness and boost revenues. Examples of the marketing efforts, businesses are engaging in include creating social networking pages dedicated to their businesses, launching deals on daily deal sites, providing online coupon codes, tweeting, provided targeted advertising, amongst others. One of the challenges such businesses are facing as a result of these increased marketing efforts is analyzing the performance of these marketing efforts. In particular, smaller businesses do not have the resources to understand which efforts are improving sales and by how much, let alone how much it is costing the business to generate these improved sales. Stated in another way, businesses are engaging with customers but have not been able to aggregate, correlate, and measure the effectiveness of their efforts given the heterogeneous nature of the various online platforms, and further yet, make decisions on which marketing efforts to pursue or drop based on their effectiveness.

It should be appreciated that each online social media platform provides a different service. For instance, FourSquare has attempted to bridge the gap between the social media and customer loyalty. As such, FourSquare is all about location and frequency. Twitter is about notifications, news and discussions. Facebook is about the “social graph” or network, while expressing “likes” and commonalities. Each social media platform focuses on achieving different goals. The interactions that occur on these different social media platforms have common use cases, but can be unique to that social platform. This results in differing user experiences and fragmented data.

At present, each social media platform is limited in logging only those activities of the user that are performed within the social network platform. In this way, for a user that is both a Facebook user and a Twitter user, Facebook may be limited to only analyze the user's activities that are performed on the Facebook social network platform, while Twitter may be limited to only analyze the user's activities that are performed on the Twitter social network platform. As such, at present, a business that engages with a user who subscribes to both Facebook and Twitter currently maintains two separate accounts for this user and the business is unaware of the relationship between the Facebook profile and the Twitter profile of the user. As a result, a business fails to maximize its ability to understand the business's customers simply because the business has no way of using the information obtained through Facebook in its marketing efforts on Twitter and vice versa. Broadly speaking, businesses currently are unable to optimize their marketing efforts since the businesses are unable to aggregate and correlate information across multiple online platforms.

Consider the example of a business that is involved in various marketing efforts across multiple online platforms. This business may have a Facebook Page, Twitter Account, a website, runs Groupon and Living Social deals, a set of SCVNGR Challenges and utilizes email and mobile marketing campaigns, all to alert the business's patrons of special offers and promotions to increase public awareness and revenue. Each of these communication media, namely Facebook, Twitter, Groupon, Living Social, SCVNGR, and others, can be used as a tool to accomplish the goals. The business can employ marketing efforts targeting each of these communication media, which utilize valuable business resources, including, time, money and other resources.

At present, one of the challenges such a business may face is determining how to aggregate, correlate, and measure the effectiveness and to make decisions given the heterogeneous nature of the various communication media. Can this business determine if those who participated in a Groupon campaign are fans of the Facebook Page, or members of the email list? To make matters worse, assume this business is a franchise, or has affiliate businesses, or even other locations that are running similar campaigns. Leveraging the customers' social activity given the variety of marketing campaigns is not an easy challenge to overcome.

To address some of these challenges, the present disclosure provides a social media data aggregation platform configured to manage and execute marketing campaigns for businesses. As part of managing and executing marketing campaigns, the social media data aggregation platform can be configured to retrieve activity data associated with existing or potential customers of the business at each of the various social media platforms. The social media data aggregation platform can then aggregate the retrieved data in a manner that allows the social media data aggregation platform to weave a fabric of all the activity data and behaviors customers create, share and communicate. By doing so, the social media data aggregation platform can create a cohesive experience and streamline the social engagement of any business. The fabric of the social media data aggregation platform is made up of all the strengths of the existing “social interactions.” This is possible by aggregating the social interactions at each of a plurality of social media platforms and evaluating the user's activities across the various social media platforms together. By forming partnerships with various social media partners, the social media data aggregation platform can seamlessly retrieve activity data of customers while allowing customers to continue to use what they are comfortable with, eliminating the barrier of creating a new experience, new app, or new social network. Additional details of methods and systems for collecting, managing and using subscriber or user information are provided herein with respect to Section B.

As such, as part of the methods and systems for creating and executing marketing campaigns, the present disclosure provides methods and systems for creating a social network fabric that weaves social media activity of users across multiple social media platforms. The social media fabric can correspond to a meta-social platform that transcends existing social media. The social media data aggregation platform that creates the social media fabric that weaves social media activity of a user across multiple social media platforms may serve as a backbone of social media by utilizing connections into each of these networks. The social media data aggregation platform can aggregate the data stored at each of the social media platforms by establishing connections into each of these social media connections. The social media data aggregation platform can leverage the data collected at each of the social media platforms with which users engage to create a new experience without requiring any new interaction from the users. The aggregated data can serve as a social graph, which becomes the fabric that weaves any participant using any social application the participant already uses. This fabric becomes a new experience with no predecessor.

In some implementations, the social media data aggregation platform can create marketing campaigns that utilizes tasks, connections between tasks, and connections between people. These tasks can be activities to boost the business's profile online and can be made up of interactions associated with a user. Examples of tasks can be location-based tasks, message tasks, profile tasks, friend tasks, challenge tasks, website tasks and puzzle tasks. A director of the social media data aggregation platform can control the tasks. Any of the tasks can exist in one of three states: “active”, “pending (another task)”, or “completed”. The director controls the set of tasks any player can execute at any given time. The director can be the author of the tasks, and the tasks can be laid out serially, in parallel, in a directed graph or even as sub graphs. A set of serial tasks would require the tasks to be completed in sequence, and upon completion there could be a special offer or reward.

These tasks can be designed to promote brand awareness for a business as well as to learn more about the user. A marketing campaign can be designed such that a coupon is offered to the user if the user completes all of the tasks assigned to the user. The tasks can include instructions to like a page on Facebook, tweet a message about the business on Twitter, taking a survey, linking the Facebook profile to the Twitter profile, amongst others. Through these tasks, businesses can learn more about their customers and can identify potential customers.

As described above, businesses currently do not have a way to determine whether a Facebook fan of theirs is also a Twitter follower. In fact, businesses sometimes are unable to even know information about the types of users that are fans of them on Facebook or follow them on Twitter. Businesses could benefit from knowing how many of their fans on Facebook are also their followers on Twitter and vice versa. Businesses also do not know which of their Facebook fans are buying coupons for the business on a daily deal site, such as Groupon, or which of their Twitter followers is leaving comments for them on a review site, such as Yelp. All of this information across multiple social media platforms is currently unrelated. By way of the methods and systems described herein, this information could be aggregated for businesses such that the businesses will be able to better understand each of their users behaviors, and to learn more about each of their users. This can help the businesses better engage with its users, improving the user's experience, which inevitably can result in an increase in sales.

The present disclosure provides methods and systems for a social network aggregation platform to manage and execute marketing campaigns. According to one aspect, a social media data aggregation platform can serve as an intermediary between one or more businesses and one or more customers. In this way, the social media data aggregation platform can establish and execute marketing campaigns targeting the customers on behalf of the businesses. The social media data aggregation platform can identify a plurality of customers to target for a marketing campaign. The social media data aggregation platform can retrieve, from a plurality of social media platforms (for example, Facebook, Twitter, Yelp, Pinterest, Groupon, Foursquare, amongst others), social media activity data associated with each of the customers. In some implementations, this is possible by receiving permission from the customer to receive activity data from the social media platforms. The social media data aggregation platform can receive the data from each of the social media platforms and aggregate the received data from each of the social media platforms for each of the customers. In this way, a social graph of the customer can be generated that includes a timeline of the activities the customer performed across multiple platforms in addition to additional information about the preferences, interests, activities of the customer. The social media data aggregation platform can further aggregate the data associated with each of the customers and analyze trends, similarities, differences, preferences, interests, across the plurality of customers. By doing so, the social media data aggregation platform can create marketing campaigns for individual customers or a subset of the plurality of customers on behalf of businesses based on each customer's individual social graph. The marketing campaigns can then be executed by the social media data aggregation platform and the results of the marketing campaigns can be analyzed.

Although in some implementations, the social media data aggregation platform utilizes social media activity data of customers to create marketing campaigns, the social media data aggregation platform can be extended to include activity data of customers that are performed outside the realm of social media. For example, consumers activity data related to what television shows they watch, who they call, who they email, which websites they visit, which retailers they purchase from, amongst others, can all be used to better understand the customers and to provide more tailored marketing campaigns.

As previously discussed above, more and more people are engaging in activities across multiple platforms that are logging activity data performed within their platform. For instance, a retailer is logging all shopping related activity performed by a customer at the retailer, a social network website is logging all social network related activities performed by the user at the social networking platform, a website is logging content viewing activity performed by a customer at the website and so forth. Although most platforms are monitoring user activities to understand user behaviors, the information that the platforms have access to is limited to the activities the user performs on their platform and any information the user provides directly to the platform. Although the logged activity data of users is somewhat useful to the platforms, these platforms oftentimes lack the context associated with the activity data of users. Stated in another way, the platforms are unaware of why the user performs a particular activity or what causes the user to perform such an activity. Moreover, the platforms are also unaware of activities the user performs before or after the user performs the particular activity. This is particularly true when users are engaging in activities at multiple platforms at around the same time. As a result, when a customer visits a particular retailer online and buys a shirt, the retailer is often unaware of the path the customer took to buy the particular shirt, whether the customer visited another site to see other shirts or to determine if the price of the shirt was appropriate, whether the customer saw a post on a social networking site regarding the shirt or the retailer, and the like. There is a desire on the part of the retailer to receive additional information about the user's activities at other platforms to see how the user reached the decision to buy the shirt. Extending this further, there is a desire to be able to share information about a user across multiple platforms to better understand user behavior.

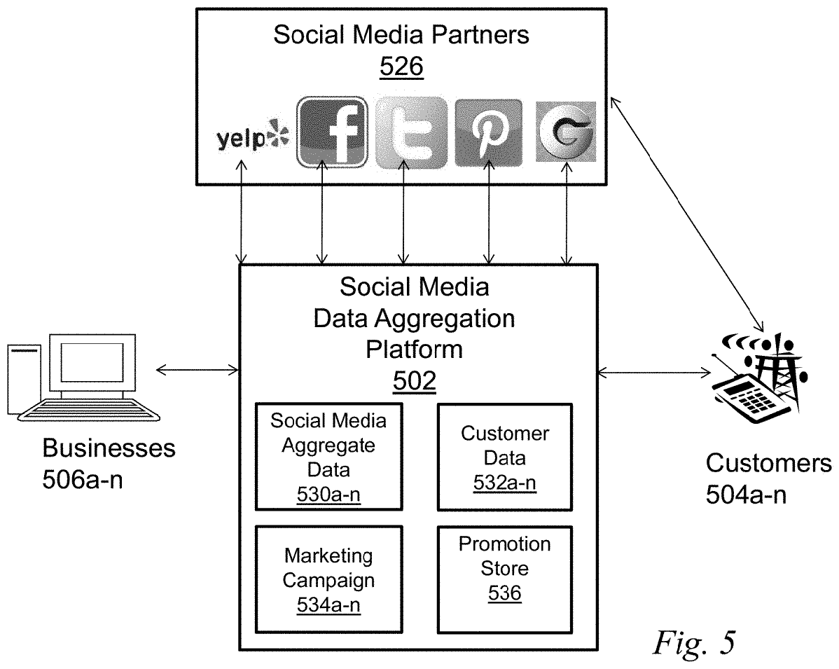

FIG. 5 is a block diagram illustrating a computer networked environment for a social media platform for creating and executing marketing campaigns. As shown in FIG. 5, the social media data aggregation platform 502 can be a part of the subscriber information management system 202 shown in FIGS. 1C and 2A. In some implementations, the social media data aggregation platform 502 can be an independent entity that does not operate within the confines of the subscriber information management system 202. In some implementations, the social media data aggregation platform 502 can be configured to utilize the subscriber information managed by the subscriber information management system 202. The subscriber information can include information about subscribers derived from the subscriber's activities at one or more of the social media partners. As will be described herein, social media data aggregation platform 502 can be configured to retrieve user activity from a plurality of social media partners, aggregate the retrieved activity and utilize the aggregated activities of users to design marketing campaigns directed towards users based on the aggregated information associated with each user.

In some implementations, the social media data aggregation platform 502 can serve as an intermediary between one or more businesses 506a-n, similar to the clients 206a-n and one or more customers 504a-n, similar to the subscribers 204a-n. In some implementations, the social media data aggregation platform 502 can serve as an agent of a business. In some implementations, the social media data aggregation platform 502 can serve as an agent for a plurality of businesses.

The social media data aggregation platform 502 can be configured to communicate with one or more customers via one or more networks. In some implementations, the social media data aggregation platform 502 can be configured to communicate with the customers via a mobile application installed on the customer's device. In some implementations, the customer can download the application on the customer's device and establish a customer account with the social media data aggregation platform 502.

The social media data aggregation platform 502 can also be configured to communicate with one or more businesses via one or more networks. In some implementations, the social media data aggregation platform 502 can be configured to communicate with the businesses via one or more programs, applications, scripts, instructions, or other software construct. The social media data aggregation platform 502 can be configured to share data with the businesses 506 as well as receive instructions to create and execute marketing campaigns.

The social media data aggregation platform 502 can also be configured to communicate with one or more social media partners 526. Examples of such social media partners can include social networking sites (for example, Facebook, Twitter, Linkedin), content sharing sites (Pinterest, Instagram), daily deal sites (Groupon, LivingSocial), Review sites (Yelp, urbanspoon), amongst others. Social media partners can be any social media platform in which one or more customers associated with the social media data aggregation platform 502 have accounts and the social media partner is collecting data associated with the customer that can be used to learn more about the customer's habits, preferences, interests, amongst others.

The social media data aggregation platform 502 can establish communications with each of the social media partners 526. In some implementations, the social media data aggregation platform 502 can do so by using APIs through which the social media data aggregation platform 502 can gain access to the social media partners 526. In some implementations, the social media data aggregation platform 502 can provide a token associated with a customer to a social media partner, which once validated or authenticated, allows the social media data aggregation platform 502 to establish a connection with the social media partner to receive customer data 532a-n corresponding to the customer whose token was provided that the social media partner has stored. The customer data can include information provided by the customer to the social media partner, activity data corresponding to activities in which the customer engaged during visits to the social media partner. Examples of such activities can include listing information about content the customer viewed, purchases the customer made, comments the customer wrote, Facebook likes, Twitter Retweets, amongst others.

In some implementations, each of the social media partners 526 may provide the customer data associated with a given customer in different formats. As such, the social media data aggregation platform can be configured to receive customer data from a variety of social media partners 526, format the received data into a format in which the data can be easily organized and accessed, and store the formatted data for efficient retrieval and analysis.

The customer data 532 received from the social media partners can be associated with a timestamp. The timestamp can be associated with an activity in which the user engaged and may indicate the time the activity occurred. In addition to timestamps, the data can include a geographic tag to indicate where the consumer device was located at the time the activity occurred. The data can include additional tags to indicate other information, for example, social tags indicating friends of the customer that were also engaged in the activity at the time of the activity, amongst others.

In some implementations, the social media data aggregation platform 502 can be configured to periodically retrieve information from each of the social media partners. In some implementations, the social media data aggregation platform 502 can make API calls to retrieve information. These calls can be made once a minute, once a day, once a week or any other reasonable time period. The API calls or requests can include a list of tokens associated with customers whose data the social media data aggregation platform 502 is requesting. In some implementations, the tokens can serve to authenticate the social media data aggregation platform 502 and allow the social media partners 526 to selectively share customer data of only those customers that have authorized the social media data aggregation platform 502 to access and retrieve their customer data. In some implementations, the social media platforms may have a relationship with one or more of the social media data aggregation platforms that allows the social media data aggregation platform 502 to retrieve all of the data the social media partner collects without restricting the collected data to only those customers for whom the social media data aggregation platform 502 has obtained authorization.

In some implementations, the social media data aggregation platform 502 can be configured to store all of the data retrieved from each of the plurality of social media partners. This data can be stored in one or more data stores. These data stores can be local to the social media data aggregation platform 502. In some implementations, these data stores can be located remotely. The social media data aggregation platform 502 can be configured to format the data retrieved from each of the social media platforms 526 to a format such that the social media data aggregation platform 502 can be configured to easily access and retrieve the formatted data. As such, the social media data aggregation platform 502 may include one or more social media platform specific formatting modules that can format the data retrieved from a specific social media platform into a common format used by the social media data aggregation platform 502.

The social media data aggregation platform 502 can be configured to create and execute marketing campaigns for one or more of the businesses 506. The businesses 506 can establish a connection with the social media data aggregation platform 502 or vice versa through which the business and the social media data aggregation platform 502 can create marketing campaigns 534a-n.

These marketing campaigns 534 can leverage the social media data aggregated across multiple social media platforms 526 and may also provide customers to participate in the marketing campaign 534 of a business across multiple social media platforms. In some implementations, the marketing campaigns 534 can leverage consumer's social graph and connections.

In some implementations, the social media data aggregation platform can be made up of “tasks,” connections between “tasks,” and connections between people. A director or campaign manager controls the tasks—the tasks are made up of interactions an end user or “player” performs. The tasks can be executed with any of their social media outlets, including email, mobile messaging and mobile apps.

In some implementations, the tasks can be any of a location task, message task, profile task, friend task, challenge task, URL task or puzzle task, amongst others. Location tasks rely on the player's location, such as using FourSquare, Facebook Check-in, Google Latitude or even the mobile web. A location task could rely on the use of RFID, WiFi or GPS signals. A message task rely on the player providing a message of some sort. For instance, social media aggregation platform the player has updated their Facebook Wall, Tweeted, sent the social media data aggregation platform a text, and commented on a Facebook Page. A profile task relies on adding content to a player's profile. This can be in the form of a message task with the condition that it is posted to the players profile on Facebook, or Google+, and so on. Another example of a profile task can include publicly declaring an interest in a particular object, for example, liking a Facebook page of a business or following a Twitter account of a business.

A friend task can rely on the player's social graph. In some implementations, friend tasks can rely on a social network connection of the player performing a task for the player. For example, the player asking a friend to comment on a post or to like a particular Facebook page of a business, or performs any of the above-mentioned tasks. Another example can include a player and their friend both completing a “location task” concurrently. A challenge task can be based on setting up a challenge that has to be completed by the player. Examples can be checking in to a store more than 5 times or retweeting 5 tweets of a business. In some implementations, the challenge task can be like a message task, but there is a notification first and awaits a particular response. It can be similar to a SCVNGR challenge. A URL task can rely on the player visiting a particular URL on the web that has a task associated with it. This also could be triggered with a Facebook Link Share or a tweet containing said URL. A puzzle task can rely on solving a puzzle. In some implementations, the player will need a rich media experience such as an installed App, or a web experience to solve the puzzle. When the puzzle is unlocked it obviously could lead to any of the aforementioned tasks.

Any of the tasks can exist in one of three states: “active,” “pending (another task),” or “completed.” The director can control the set of tasks any player can execute at any given time. The director can be the author of the tasks, and the tasks can be laid out serially, in parallel, in a directed graph or even as sub graphs. A set of serial tasks would require the tasks to be completed in sequence, and upon completion there could be a special offer or reward.

In some implementations, the director of the social media data aggregation platform can monitor one or more tasks. The director can determine if one or more of the tasks have been completed. In some implementations, the director can be configured to retrieve data from one or more of the social media platforms to determine if the user has completed a task. For example, if one of the tasks was to like a page of a business on Facebook, the director can retrieve user information from Facebook and determine if one of the activities performed by the user on Facebook included liking the page of the business. In some implementations, the director can retrieve this information via the subscriber information management system 202 described above with respect to FIG. 2. In some implementations, the subscriber information management system can organize the retrieved information and compare it to the tasks assigned by the director. In some implementations, the subscriber information management system and the director can communicate to identify a status of a task across one or more social media platforms.

The director can be configured to create tasks that help link two social media platforms. For instance, the director can be configured to create a task requiring the user to share a post on a business's Facebook profile on Twitter or vice versa. To determine if the task is completed, the director can monitor activity information on both social media platforms.

In some implementations, the director or the social media data aggregation platform can be configured to analyze activity information and associated timestamps. For instance, if a user views an advertisement on Facebook at a first time, makes a purchase at a website associated with the ad at a second time, and then shares the purchase on Twitter at a third time, the social media data aggregation platform can learn more about the user's shopping behavior. For instance, the user can be influenced by an ad on Facebook and is willing to share news of purchases on Twitter.

In some implementations, the director can be configured to monitor the social network platforms in real time. In some implementations, the director can utilize API calls to retrieve any information from each of the social media platforms for multiple users. The API call can include the identity of a user that has authorized the social media data aggregation platform to collect information. The API call can be made periodically, for example, every hour, every few hours, daily or less than once a day. In some implementations, the director can establish a connection with one or more social media platforms such that the data logged by the social media platforms is shared with the director either in real time or periodically.

Any marketing campaign created by the social media data aggregation platform 502 may include one or more entry points. For example, to begin engagement in the social media data aggregation platform experience, entry points into the social media data aggregation platform may be defined and interactions between the various social media platforms can be aggregated. A simple entry point example is a text message campaign. By texting a particular keyword to a short code assigned to the social media data aggregation platform, the new player's mobile number is received and an associated SMS message task is executed. From there, the player can be presented with a URL customized for their profile which allows them to get the social media data aggregation platform with Facebook, Google+, Twitter, FourSquare, Flickr, Yahoo, Yelp, Pinterest, Groupon, LivingSocial, amongst others, using some authentication module, for example, an authentication module that relies on an OAuth API. OAuth essentially allows a third party (for example, the social media data aggregation platform) to interface with the users account on any of the aforementioned social networks. From here, the social media data aggregation platform 502 is able to weave the various social network accounts of a player together allowing a cohesive profile for that player. Other examples of entry points can include: posts to the Facebook Page, tweeting a URL, amongst others. To make things even more interesting, each new social account connection made can complete a task for that business.

Now that the social media data aggregation platform 502 has associated the different social platforms with a customer 504 or player, the value of each customer, as well as the effectiveness of different marketing campaigns with regard to specific segments of the user base can be measured. In some implementations, the marketing campaign can be designed, constructed or configured such that each task of the marketing campaign can be assigned an associated value. In this way, the social media data aggregation platform 502 can create a scoring system.

The scoring serves a number of purposes. To the player, the player can determine how the player measures up to other players for that brand. Secondly, the player can earn rewards from the business or brand based off their score. To the business, the score clearly gives the business a pulse of their customer base. By segmenting players based off their social profiles, the business can see who is most engaged. Businesses also can see what campaigns are most effective given the campaigns are associated to tasks. This ushers in a new dynamic to social engagement for everyone.

For certain enterprises, the data generated by the users and controlled by the social media data aggregation platform is of great value in and of itself. The social media data aggregation platform 502 will provide various connectors of this social data into the big-data systems the enterprises manage internally.

As is evident from the description, there is a benefit to aggregate the Facebook Fan Page and Apps, Twitter Feed, Google+circles, FourSquare promotions, email and mobile campaigns and analyze these together. One of the goals of social media data aggregation platform 502 is to be platform agnostic, device agnostic and social media platform agnostic. This requires that the social media data aggregation platform deliver the promotion through the channel that will be most effective for the participant. In some implementations, a central promotion store 536 may be a logical place to store promotions received while participating in a social media data aggregation platform enabled promotion. In some implementations, Apple's Passbook can serve as a promotion store for storing earned promotions or awards. The options are endless and any promotion delivery should be through a variety of channels.

One of the benefits the social media data aggregation platform can bring to fruition is the ability for businesses to analyze their marketing campaigns to see which marketing channel generates the greatest return on investment of marketing budgets. Imagine a sushi restaurant that advertises through multiple social media channels. For example, it launches a Facebook ad campaign targeting all social network users that reside within 25 miles of a zip code of the restaurant and have indicated an interest for one or more other restaurants in any of their social network profiles. In addition, the sushi restaurant launches a Groupon deal offering a discount at the restaurant. Through the social media data aggregation platform, the business can identify all the users to which the Facebook ads were served, can identify whether any of those users also made Groupon deal purchases, can infer based on timestamp data or browsing history data if accessible to the social media data aggregation platform, whether the Facebook ad resulted in the purchase of the Groupon deal, and can further follow up from the user's aggregated data, whether the user actually converted. For instance, the user may have posted a photo of the dish they ordered or checked in through Foursquare or left a review at Yelp. By being able to track the user's social behavior as well as the social behaviors of a large number of users, the sushi restaurant can refine their marketing efforts and perhaps design marketing campaigns through which the users can collectively increase the brand awareness of the sushi restaurant (by setting up challenges as described above).

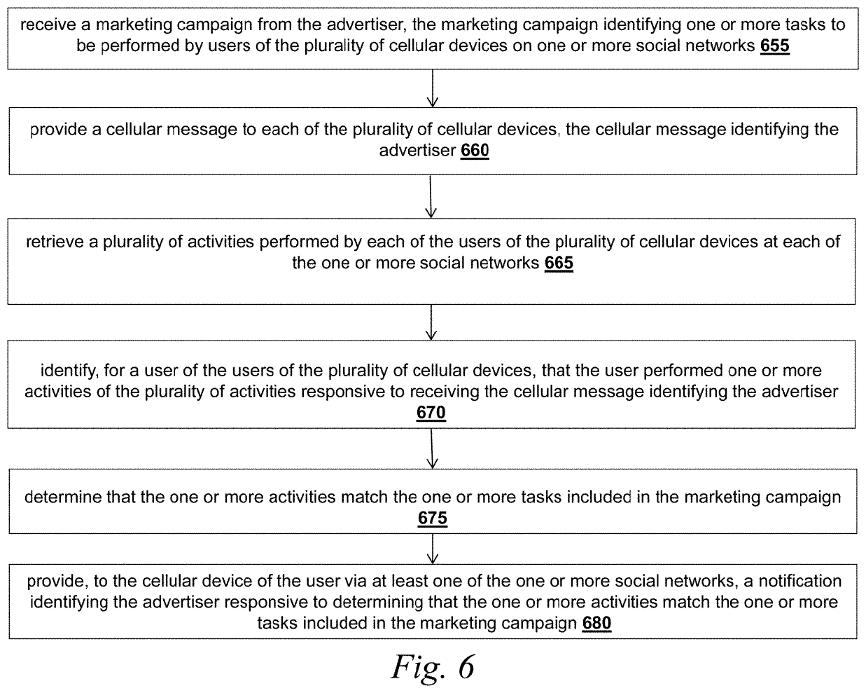

Referring now to FIG. 6, FIG. 6 is a flow diagram of a method of executing a cross-platform marketing campaign. A social media aggregation system intermediary to an advertiser and a plurality of cellular devices receives a marketing campaign from the advertiser (BLOCK 655). The marketing campaign identifies one or more tasks to be performed by users of the plurality of cellular devices on one or more social networks. The social media aggregation system provides a cellular message to each of the plurality of cellular devices, the cellular message identifying the advertiser (BLOCK 660). The social media aggregation system retrieves a plurality of activities performed by each of the users of the plurality of cellular devices at each of the one or more social networks (BLOCK 665). The social media aggregation system identifies, for a user of the users of the plurality of cellular devices, that the user performed one or more activities of the plurality of activities responsive to receiving the cellular message identifying the advertiser (BLOCK 670). The social media aggregation system determines that the one or more activities match the one or more tasks included in the marketing campaign (BLOCK 675). The social media aggregation system then provides, to the cellular device of the user via at least one of the one or more social networks, a notification identifying the advertiser in response to determining that the one or more activities match the one or more tasks included in the marketing campaign (BLOCK 680).

In further detail, the social media aggregation system receives a marketing campaign from the advertiser (BLOCK 655). The marketing campaign identifies one or more tasks to be performed by users of the plurality of cellular devices on one or more social networks. In some implementations, the marketing campaign can include one or more tasks to be performed by one or more subscribers. In some implementations, the tasks can be designed to be performed on social networking websites. In some implementations, the tasks can be designed to be performed on one or more unrelated content sources, including websites, mobile applications, social networks, among others. In some implementations, the tasks can be designed to be performed across multiple marketing channels, for example, SMS, email, social networks, etc.

In some implementations, the marketing campaign can be created by an advertiser. In some implementations, the social media aggregation system can be configured to create a marketing campaign for a particular advertiser. In some implementations, the social media aggregation system may look at historical activity performed by subscribers and develop a marketing campaign based on previous behaviors of subscribers to which to target. In some implementations, the social media aggregation system may design a marketing campaign that involves sending multiple messages to the subscribers via SMS, social media, email, among others.

In some implementations, the tasks can include functions that a subscriber can perform. For example, a task can include clicking on a link in an SMS message, commenting or sharing a post on a social networking site, tweeting, sending an email, making a conversion, among others. In some implementations, the tasks can be linked to coupons, rewards, or other items that can be sent to the subscriber if the subscriber successfully completes the tasks.

The social media aggregation system provides a cellular message to each of the plurality of cellular devices, the cellular message identifying the advertiser (BLOCK 660). In some implementations, the cellular message includes a link, which when clicked, causes a social network application to launch on the cellular device. In some implementations, the social media aggregation system can send the SMS message or MMS message via an SMPP connection. In some implementations, the social media aggregation system can send the SMS message that includes content related to the advertiser. The content can be a link, which when clicked, can cause a native application of another content source to launch. In some implementations, the link can be configured to post a content item on a social networking site, such as Facebook, Twitter or Pinterest.

The social media aggregation system can be configured to store activity data in response to sending the cellular message to the subscribers In some implementations, the social media aggregation system can store activity data relating to the cellular message for each subscriber to which the cellular message was transmitted. In some implementations, the social media aggregation system may store a unique identifier identifying the content item included in the cellular message in a subscriber record along with the activity data.

The social media aggregation system retrieves a plurality of activities performed by each of the users or subscribers of the plurality of cellular devices at each of the one or more social networks (BLOCK 665). In some implementations, the social media aggregation system can retrieve, for each subscriber, one or more activities performed by the subscriber responsive to receiving the cellular message. In some implementations, the social media aggregation system can identify that the subscriber clicked on a link included in the cellular message. In some implementations, the social media aggregation system can identify the content item included in the cellular message and determine one or more activities performed on the content item. For example, if the content item is posted to a social network, the social media aggregation system can store the activities associated with the content item in the subscriber record.

In some implementations, the social media aggregation system can receive, from each of the cellular devices, an indication to access content of the social networks related to the user of the cellular device. In some implementations, the social media aggregation system can do so by determining that the subscriber clicked on the link included in the cellular message.

The social media aggregation system identifies, for a user of the users of the plurality of cellular devices, that the user performed one or more activities of the plurality of activities responsive to receiving the cellular message identifying the advertiser (BLOCK 670). In some implementations, the social media aggregation system can receive data corresponding to activities performed at the one or more social networks via native applications installed on the cellular devices of users. In some implementations, the social media aggregation system can receive data corresponding to one or more activities performed by the user on the cellular device from one or more services executing on the cellular device. In some such implementations, the one or more services include a phone service, an email service, an instant messaging service, and a camera service.

In some implementations, retrieving a plurality of activities performed by each of the users of the plurality of cellular devices at each of the one or more social networks includes retrieving, for each user, activity data corresponding to a particular activity. The activity data can include a time stamp indicating a time the activity was performed and a location stamp indicating a location of the user when the activity was performed a time stamp.

In some implementations, the social media aggregation system can retrieve data corresponding to activities performed by one or more subscribers via APIs that interface with servers of the content sources. In some implementations, the social media aggregation system can retrieve the data periodically or each time an activity is detected. In some implementations, the social media aggregation system can identify activity associated with a particular content item such that when an action is taken on the content item, the social media aggregation system can retrieve information. In some implementations, the activity data related to the content item can be stored in a content item record specific to the content item. In some implementations, the content item record can include activity data of multiple subscribers that interacted with the content item. For example, if a subscriber shares a content item with a friend and the friend then shares it with another friend, the social media aggregation system can maintain the content item record containing the activity performed by the subscriber, the friend and the friend's friend in regard to the content item. As the activity data is associated with a time stamp and location data, a social graph can be generated outlining the interactions of multiple subscribers with the content item over a period of time.

The social media aggregation system determines that the one or more activities match the one or more tasks included in the marketing campaign (BLOCK 675). In some implementations, the one or more tasks include one of sharing of, commenting on or expressing an indication of interest on a particular content included in at least one of the one or more social networks. In some implementations, the social media aggregation system can identify an activity performed on the content item included in the marketing campaign and determine if the activity corresponds to one of the tasks associated with the marketing campaign.

The social media aggregation system then provides, to the cellular device of the user via at least one of the one or more social networks, a notification identifying the advertiser in response to determining that the one or more activities match the one or more tasks included in the marketing campaign (BLOCK 680). In some implementations, the notification includes an electronic content item redeemable towards a purchase of a product or service promoted by the advertiser. In some implementations, the user of the cellular device is a first user and the social media aggregation system further determines that a second user performed a second activity on a content item responsive to the first user performing a first activity on the content item and provides, to the cellular device of the first user, the notification responsive to determining that the second user performed the second activity on the content item. In some implementations, the notification can be generated by the social media aggregation system. The reward included in the notification can be selected based on one or more parameters identified in the marketing criteria. In some implementations, the notification can be sent as a cellular message. In some implementations, the notification can be a push notification.

While the invention has been particularly shown and described with reference to specific embodiments, it should be understood by those skilled in the art that various changes in form and detail may be made therein without departing from the spirit and scope of the invention described in this disclosure.

While this specification contains many specific embodiment details, these should not be construed as limitations on the scope of any inventions or of what may be claimed, but rather as descriptions of features specific to particular embodiments of particular inventions. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

What is claimed is:

1. A method of executing a cross-platform marketing campaign, comprising:
receiving, by a social media aggregation system including one or more processors intermediary to an advertiser and a plurality of cellular devices, a marketing campaign from the advertiser, the marketing campaign identifying one or more tasks to be performed by users of the plurality of cellular devices on one or more social networks;
providing, by the social media aggregation system, a cellular message to each of the plurality of cellular devices, the cellular message identifying the advertiser;
retrieving, by the social media aggregation system, a plurality of activities performed by each of the users of the plurality of cellular devices at each of the one or more social networks;
identifying, by the social media aggregation system, for a user of the users of the plurality of cellular devices, that the user performed one or more activities of the plurality of activities responsive to receiving the cellular message identifying the advertiser;
determining, by the social media aggregation system, that the one or more activities match the one or more tasks included in the marketing campaign; and
providing, to the cellular device of the user via at least one of the one or more social networks, a notification identifying the advertiser responsive to determining that the one or more activities match the one or more tasks included in the marketing campaign.

2. The method of claim 1, wherein the cellular message includes a link, which when clicked, causes a social network application to launch on the cellular device.

3. The method of claim 1, wherein the one or more tasks include one of sharing of, commenting on or expressing an indication of interest on a particular content included in at least one of the one or more social networks.

4. The method of claim 1, further comprising receiving, by the social media aggregation system, from each of the cellular devices, an indication to access content of the social networks related to the user of the cellular device.

5. The method of claim 1, further comprising receiving, by the social media aggregation system, data corresponding to activities performed at the one or more social networks via native applications installed on the cellular devices of users.

6. The method of claim 1, further comprising receiving, by the social media aggregation system, data corresponding to one or more activities performed by the user on the cellular device from one or more services executing on the cellular device.

7. The method of claim 6, wherein the one or more services include a phone service, an email service, an instant messaging service, and a camera service.

8. The method of claim 1, wherein retrieving a plurality of activities performed by each of the users of the plurality of cellular devices at each of the one or more social networks includes retrieving, for each user, activity data corresponding to a particular activity, the activity data including a time stamp indicating a time the activity was performed and a location stamp indicating a location of the user when the activity was performed a time stamp.

9. The method of claim 1, wherein the notification includes an electronic content item redeemable towards a purchase of a product or service promoted by the advertiser.

10. The method of claim 1, wherein the user of the cellular device is a first user and wherein the method further comprises:
determining, by the social media aggregation system, that a second user performed a second activity on a content item responsive to the first user performing a first activity on the content item; and
wherein providing, to the cellular device of the user via at least one of the one or more social networks, a notification includes providing, to the cellular device of the first user, the notification responsive to determining that the second user performed the second activity on the content item.

11. A system of executing a cross-platform marketing campaign, comprising:
a social media aggregation system intermediary to an advertiser and a plurality of cellular devices, the social media aggregation system including
a memory; and
one or more processors, the one or more processors configured to
receive a marketing campaign from the advertiser, the marketing campaign identifying one or more tasks to be performed by users of the plurality of cellular devices on one or more social networks;
provide a cellular message to each of the plurality of cellular devices, the cellular message identifying the advertiser;
retrieve a plurality of activities performed by each of the users of the plurality of cellular devices at each of the one or more social networks;
identify, for a user of the users of the plurality of cellular devices, that the user performed one or more activities of the plurality of activities responsive to receiving the cellular message identifying the advertiser;
determine that the one or more activities match the one or more tasks included in the marketing campaign; and
provide, to the cellular device of the user via at least one of the one or more social networks, a notification identifying the advertiser responsive to determining that the one or more activities match the one or more tasks included in the marketing campaign.

12. The system of claim 11, wherein the cellular message includes a link, which when clicked, causes a social network application to launch on the cellular device.

13. The system of claim 11, wherein the one or more tasks include one of sharing of, commenting on or expressing an indication of interest on a particular content included in at least one of the one or more social networks.

14. The system of claim 11, wherein the processors further configured to receive, from each of the cellular devices, an indication to access content of the social networks related to the user of the cellular device.

15. The system of claim 11, wherein the processors further configured to receive data corresponding to activities performed at the one or more social networks via native applications installed on the cellular devices of users.

16. The system of claim 11, wherein the processors further configured to receive data corresponding to one or more activities performed by the user on the cellular device from one or more services executing on the cellular device.

17. The system of claim 16, wherein the one or more services include a phone service, an email service, an instant messaging service, and a camera service.

18. The system of claim 11, wherein retrieving a plurality of activities performed by each of the users of the plurality of cellular devices at each of the one or more social networks includes retrieving, for each user, activity data corresponding to a particular activity, the activity data including a time stamp indicating a time the activity was performed and a location stamp indicating a location of the user when the activity was performed a time stamp.

19. The system of claim 11, wherein the notification includes an electronic content item redeemable towards a purchase of a product or service promoted by the advertiser.

20. The system of claim 11, wherein the user of the cellular device is a first user and wherein the processors further configured to:
determine that a second user performed a second activity on a content item responsive to the first user performing a first activity on the content item; and
wherein providing, to the cellular device of the user via at least one of the one or more social networks, a notification includes providing, to the cellular device of the first user, the notification responsive to determining that the second user performed the second activity on the content item.
